(19) United States
(12) Patent Application Publication
(10) Pub. No.: US 2024/0165748 A1
(43) Pub. Date: May 23, 2024

(54) Connecting part for a processing head for thermal material processing

(71) Applicant: Kjellberg-Stiftung, Finsterwalde (DE)

(72) Inventors: Vadim GÜNTHER, Finsterwalde (DE); Timo GRUNDKE, Finsterwalde (DE); Frank LAURISCH, Finsterwalde (DE); Volker KRINK, Finsterwalde (DE)

(73) Assignee: Kjellberg-Stiftung, Finsterwalde (DE)

(21) Appl. No.: 18/430,228

(22) Filed: Feb. 1, 2024

Related U.S. Application Data
(62) Division of application No. 17/263,870, filed on Jan. 27, 2021.

(30) Foreign Application Priority Data
Jul. 27, 2018 (DE) 102018005914.7
Oct. 17, 2018 (DE) 102018125772.4

(51) Int. Cl. B23K 37/00; B23K 9/32; B23K 26/14; F16J 15/06; H05H 1/34; B23K 10/00; F16L 21/03; F16L 21/035

(52) U.S. Cl. CPC B23K 37/00; B23K 9/321; B23K 26/1482; F16J 15/062; H05H 1/3423; B23K 10/00; B23K 37/003; F16L 21/03; F16L 21/035

(57) ABSTRACT

Connecting parts for a processing head for thermal material processing, comprises a body that extends along a longitudinal axis having an outer face, an inner face, a front end, and a rear end; and the inner face or the outer face has a slot, extending in the circumferential direction, with each slot having a slot depth and a slot bottom, wherein the slot bottom exhibits, around the circumference, different distances extending through the longitudinal axis and perpendicularly to the longitudinal axis between the opposite portions of the slot bottom, and one inner face or outer face exhibits, around the circumference, different distances, extending through the longitudinal axis and perpendicularly to the longitudinal axis, between the opposite portions of the inner face or outer face.

### BACKGROUND

Processing heads for thermal material processing, for example plasma torch heads, laser heads and plasma laser heads, are used very generally for the thermal processing of materials of very different kinds, such as metal and non-metal materials, for example for cutting, welding, inscribing or very generally for heating.

Plasma torches usually consist of a torch body, an electrode, a nozzle and a mount therefor. Modern plasma torches additionally have a nozzle protective cap fitted over the nozzle. Often, a nozzle is fixed by means of a nozzle cap.

The components that become worn through operation of the plasma torch as a result of the high thermal load caused by the arc are, depending on the plasma torch type, in particular the electrode, the nozzle, the nozzle cap, the nozzle protective cap, the nozzle protective-cap mount and the plasma-gas and secondary-gas guiding parts. These components can be changed easily by an operator and are therefore denoted wearing parts.

The plasma torches are connected via lines to a power source and a gas supply, which supply the plasma torch. Furthermore, the plasma torch can be connected to a cooling device for a cooling medium, for example a cooling liquid.

Particularly in plasma cutting torches, high thermal loads occur. These are caused by marked constriction of the plasma jet by the nozzle bore. Use is made here of small bores in order that high current densities of 50 to 150 A/mm² in the nozzle bore, high energy densities of about 2×10⁶ W/cm² and high temperatures of up to 30 000 K are generated. Furthermore, in plasma cutting torches, higher gas pressures, as a rule up to 12 bar, are used. The combination of high temperature a high kinetic energy of the plasma gas flowing through the nozzle bore causes the workpiece to melt and the molten material to be driven out. A kerf is produced and the workpiece is separated. During plasma cutting, use is often made of oxidizing gases, for cutting unalloyed and low-alloy steels, and non-oxidizing gases, for cutting high-alloy steels and non-ferrous metals.

Between the electrode and the nozzle there flows a plasma gas. The plasma gas is guided by a gas guiding part. As a result, the plasma gas can be directed in a targeted manner. Often, as a result of a radial and/or axial offset of the openings in the plasma-gas guiding part, it is set in rotation about the electrode. The plasma-gas guiding part consists of electrically insulating material, since the electrode and the nozzle have to be electrically insulated from one another. This is necessary since the electrode and the nozzle have different electric potentials during operation of the plasma cutting torch. In order to operate the plasma cutting torch, an arc is generated between the electrode and the nozzle and/or the workpiece, said arc ionizing the plasma gas. In order to ignite the arc, a high voltage can be applied between the electrode and the nozzle, this ensuring preionization of the section between the electrode and the nozzle and thus the formation of an arc. The arc burning between the electrode and the nozzle is also known as a pilot arc.

The pilot arc exits through the nozzle bore and strikes the workpiece and ionizes the section as far as the workpiece. As a result, the arc can formed between the electrode and the workpiece. This arc is also known as a main arc. During the main arc, the pilot arc can be turned off. However, it can also continue to be run. During plasma cutting, it is often turned off in order not to additionally load the nozzle.

In particular the electrode and the nozzle are highly thermally loaded and need to be cooled. At the same time, they also have to conduct the electric current required for forming the arc. Therefore, materials with good thermal conductivity and good electrical conductivity are used for this purpose, usually metals, for example copper, silver, aluminium, tin, zinc, iron or alloys in which at least one of these metals is contained.

The electrode often consists of an electrode holder and an emission insert, which is produced from a material that has a high melting point (≥2000° C.) and a lower electron work function than the electrode holder. When non-oxidizing plasma gases, for example argon, hydrogen, nitrogen, helium and mixtures thereof, are used, tungsten is used as material for the emission insert, and when oxidizing gases, for example oxygen, air and mixtures thereof, nitrogen/oxygen mixture and mixtures with other gases, are used, hafnium or zirconium are used as materials for the emission insert. The high-temperature material can be fitted in an electrode holder that consists of a material with good thermal conductivity and good electrical conductivity, for example pressed in with a form-fit and/or force-fit.

The electrode and the nozzle can be cooled by gas, for example the plasma gas or a secondary gas that flows along the outer side of the nozzle. However, cooling with a liquid, for example water, is more effective. In this case, the electrode and/or the nozzle are often cooled directly with the liquid, i.e. the liquid is in direct contact with the electrode and/or the nozzle. In order to guide the cooling liquid around the nozzle, there is a nozzle cap around the nozzle, the inner face of said nozzle gap forming, with the outer face of the nozzle, a coolant space in which the coolant flows.

In modern plasma cutting torches, a nozzle protective cap is additionally located outside the nozzle and/or the nozzle cap. The inner face of the nozzle protective cap and the outer face of the nozzle or of the nozzle cap form a space through which a secondary or protective gas flows. The secondary or protective gas passes out of the bore in the nozzle protective cap and envelops the plasma jet and ensures a defined atmosphere around the latter. In addition, the secondary gas protects the nozzle and the nozzle protective cap from arcs that can form between the latter and the workpiece. These are known as double arcs and can result in damage to the nozzle. In particular during piercing of the workpiece, the nozzle and nozzle protective cap are highly stressed by hot material splashing up. The secondary gas, the volumetric flow of which during piercing can be higher than the value during cutting, keeps the material splashing up away from the nozzle and the nozzle-protective cap and thus protects them from damage.

The nozzle protective cap is likewise highly thermally loaded and needs to be cooled. Therefore, for this purpose, use is made of materials with good thermal conductivity and good electrical conductivity, usually metals, for example copper, silver, aluminium, tin, zine, iron or allows in which at least one of these metals is contained.

The electrode and the nozzle can also be indirectly cooled. In this case, they are in touching contact with a component that consists of a material with good thermal conductivity and good electrical conductivity, usually a metal, for example copper, silver, aluminium, tin, zinc, iron or alloys in which at least one of these metals is contained. This component is in turn cooled directly, i.e. it is in direct contact with the usually flowing coolant. These components can be used at the same time as a mount or receptacle for the electrode, the nozzle, the nozzle cap or the nozzle protective cap, and dissipate the heat and feed the current.

It is also possible for only the electrode or only the nozzle to be cooled with liquid. The nozzle protective cap is usually cooled only by the secondary gas. Arrangements are also known in which the secondary-gas cap is cooled directly or indirectly by a cooling liquid.

Laser heads consists substantially of a body, an optical system in the body for focusing the laser beam, connections for the laser light supply and the optical waveguide, gas (cutting gas and secondary gas) and cooling medium, and a nozzle having an opening that forms the gas jet of the gas and through which the laser beam also passes out of the laser head. The laser beam strikes a workpiece and is absorbed.

During laser cutting, in combination with the cutting gas, the heated workpiece is melted and driven out (laser fusion cutting) or oxidized (laser oxygen cutting).

In the case of the laser cutting head, it is possible for a nozzle protective cap to be additionally located outside the nozzle. The inner face of the nozzle protective cap and the outer face of the nozzle or of the nozzle cap form a space through which a secondary or protective gas flows. The secondary or protective gas passes out of the bore in the nozzle protective cap and envelops the laser beam and ensures a defined atmosphere around the latter. In addition, the secondary gas protects the nozzle. In particular, during piercing of the workpiece, the nozzle is highly stressed by hot material splashing up. The secondary gas, the volumetric flow of which during piercing can be higher than the value during cutting, keeps the material splashing up away from the nozzle and thus protects it from damage.

Processing heads in which both the plasma process and the laser process are used at the same time, known as plasma laser cutting heads, have features of the plasma torch head and of the laser head. Here, the features and thus also the advantages of both processes are combined with one another.

With the plasma process and the laser process and the combination, material can in principle be cut, welded, inscribed, removed or generally heated.

In plasma torches or processing heads for thermal processes, for example for cutting or welding, parts are often fitted in one another, which come into contact with fluids (gases, liquids). In this case, these fluids flow along faces of the torch parts or flow through the latter via openings (bores, channels). In this case, these can be individual parts, for example wearing parts, which become worn during operation and have to be replaced occasionally by the operator.

However, they can also be assemblies assembled from a plurality of parts, for example a torch head, which is intended to be changed occasionally.

This should be able to take place as easily and safely as possible. In this case, it is important that as little force be required for fitting in particular the wearing parts into the wearing-part mount or for fitting the wearing parts in one another, with a sealed connection nevertheless being ensured. Sealed means in this case that no fluid, i.e. no gas and/or liquid, up to a pressure, for example up to 20 bar, passes out from the inner region or in from the outside through the sealing point.

In addition, precise axial, radial or rotational positioning of the wearing parts with respect to one another or of the wearing parts with respect to the wearing-part mount is often necessary at the same time.

The previously known arrangements consist of a slot, extending around an annular circumference on the cylindrical outer or inner face, in which an O-ring is located, and of an opposite likewise cylindrical inner or outer face of the wearing-part mount or of some other wearing part, which likewise extends around an annular circumference. The O-ring protrudes at its circumference from the slot and, during fitting, is pressed into the slot by contact with the opposite face and in the process deformed. The O-ring consists of elastically deformable material, for example an elastomer. The cross section of the slot should have at least the size of the cross section of the cord of the O-ring.

The opposite face of the wearing-part mount or of the wearing part consists usually of a material that is not or is only slightly deformable elastically, for example a metal, ceramic or a hard plastic. The surface of the O-ring in this case comes into contact, around its entire circumference, with the opposite face before the deformation of the O-ring starts. As a result, high force application is necessary during fitting.

In addition, clear rotational positioning about a longitudinal axis of the connecting part is necessary between the connecting parts or the wearing parts and a wearing-part mount or between the wearing parts. This is also not possible with the known arrangement.

### SUMMARY

The aim of the present invention is to reduce the force required during fitting and/or, if possible, to ensure clear axial, radial and rotational positioning with respect to a longitudinal axis between the connecting parts, for example wearing parts.

According to the invention, this object is achieved by a method for fitting or plugging a first connecting part 100 into a second connecting part 200 of a processing head for thermal material processing, the first connecting part having, on an encircling outer face no, and/or the second connecting part 200 having, on an encircling inner face 240, at least one slot 130, 230, extending at least around a partial circumference, with a slot width B130, B230 and a slot depth T130, T230, T112, T120, which receives an O-ring 132, 232 or profile ring, extending around the entire circumference, with a cord size Sa, wherein, when the first connecting part 100 is fitted or plugged into the second connecting part 200, the O-ring 132, 232 or profile ring is initially in contact with the opposite inner face 240, 242, 244 or opposite outer face 110, 112, 142 only around a partial circumference, which extends along the slot 130, 230, or around a plurality of partial circumferences, which extend along the slot 130, 230.

Furthermore, this object is achieved by a connecting part 100, 200 for a processing head for thermal material processing, comprising a body 106, 206 that extends along a longitudinal axis L with an outer face 110, 212 and/or inner face 140, 240, with a front end 102, 202 and a rear end 104, 204, wherein the outer face 110 and/or the inner face 240 has at least one slot 130, 230, extending in the circumferential direction, with a slot width B130, B230 and a slot depth T130, T230, wherein at least one lateral boundary 114, 118, 214, 218 of the slot 130, 230 exhibits, around its circumference, distances L128, L228, of different sizes and extending parallel to the longitudinal axis L, in the direction of the front end 102, 202 and/or distances L112, L212, of different sizes and extending parallel to the longitudinal axis, from the rear end 104, 204 of the connecting part 100, 200. In other words, in the connecting part, the slot extends obliquely to the longitudinal axis of the body.

Furthermore, this object is achieved by a connecting part 100, 200 for a processing head for thermal material processing, comprising a body 106, 206 that extends along a longitudinal axis L with an outer face 110, 212 and/or inner face 140, 240, with a front end 102, 202 and a rear end 104, 204, wherein the outer face 110 and/or the inner face 240 has at least one slot 130, 230, extending in the circumferential direction, with a slot width B130, B230 and a slot depth T130, T230 having an O-ring 132, 232 or profile ring with a cord size Sa, wherein that face of the O-ring 132, 232 or profile ring that faces in the direction of the front end 102, 202 exhibits, around its circumference, distances L128a, L228, of different sizes and extending parallel to the longitudinal axis L, from the front end 102, 202 and/or that face of the O-ring 132, 232 that faces in the direction of the rear end 104, 204 exhibits, around its circumference, distances L112a, L212a, of different sizes and extending parallel to the longitudinal axis L, from the rear end 104, 204 of the connecting part 100, 200. In other words, in the connecting part, the O-ring extends obliquely to the longitudinal axis of the body.

Moreover, this object is achieved by a connecting part 100, 200 for a processing head for thermal material processing, comprising a body 106, 206 that extends along a longitudinal axis L, with an outer face 110, 112, 120, 212 and/or inner face 140, 240, 244 with a front end 102, 202 and a rear end 104, 204, wherein the outer face 110 and/or the inner face 240 has at least one slot 130, 230, extending in the circumferential direction, with a slot depth T130, T112, T120, T230, wherein the slot bottom 116, 216 of the slot 130, 230 exhibits, around the circumference, different distances D116, extending through the longitudinal axis L and perpendicularly to the longitudinal axis L, between the opposite portions of the slot bottom 116, 210 of the slot 130, 230 and/or wherein at least one outer face 112 and/or 120 exhibits, around the circumference, different distances D112, D120, extending through the longitudinal axis L and perpendicularly to the longitudinal axis L, between the opposite portions of the outer face 112, 120 and/or wherein at least one inner face 244 exhibits, around the circumference, different distances D244, extending through the longitudinal axis L and perpendicularly to the longitudinal axis L, between the opposite portions of the inner face 244. Therefore, the outer face and/or the inner face is not circular, for example elliptical.

Moreover, this object is achieved by a connecting part 100, 200 for a processing head for thermal material processing, comprising a body 106, 206 that extends along a longitudinal axis L, with an outer face 110, 112, 120, 212 and/or inner face 140, 240, 244 with a front end 102, 202 and a rear end 104, 204, wherein the outer face no and/or the inner face 230 has a slot 130, 230, extending in the circumferential direction, with a slot width B130, B230 and a slot depth T130, T112, T120, T230 having an O-ring 132, 232 or profile ring with a cord size Sa, wherein the innermost face 132i, directed towards the longitudinal axis L, of the O-ring 132, 232 exhibits, around the circumference, different distances D132i, extending through the longitudinal axis L and perpendicularly to the longitudinal axis L, between the opposite portions of the innermost face 132i of the O-ring and/or wherein the outermost face 132a of the O-ring 132, 232 exhibits, around the circumference, different distances D132a, extending through the longitudinal axis L and perpendicularly to the longitudinal axis L, between the opposite portions of the outermost face 132a of the O-ring. The innermost face, directed towards the longitudinal axis, and/or the outermost face of the O-ring is not circular, for example elliptical.

Furthermore, the present invention provides an arrangement made up of a first connecting part and a second connecting part, wherein at least one of the first and second connecting parts is a connecting part according to one of the claims.

At least in one particular embodiment, the advantages of the invention are achieved even with a very small change in the overall size, in order to realize a space-saving arrangement, in particular in the case of wearing parts.

### BRIEF DESCRIPTION OF DRAWINGS

Further features and advantages of the invention will become apparent from the appended claims and from the following description, in which a plurality of exemplary embodiments of the invention are described with reference to the schematic drawings, in which:

FIG. 1 shows a side view of a connecting part according to one particular embodiment of the present invention;

FIGS. 1a to 1c show, by way of example, different slot shapes;

FIG. 1d shows a side view of the connecting part from FIG. 1 with an O-ring;

FIG. 2 shows a sectional view of a further connecting part according to one particular embodiment of the present invention;

FIGS. 3a and 3b show sectional views of the connection of the connecting part from FIG. 1d and the connecting part from FIG. 2 in differently fitted states;

FIG. 4 shows a side view of a connecting part according to a further particular embodiment of the present invention;

FIG. 4a shows the connecting part from FIG. 4 with an O-ring;

FIGS. 5a and 5b show sectional views of the connecting part from FIG. 4a and the connecting part from FIG. 2 in differently fitted states;

FIG. 6 shows a sectional view of a connecting part according to a further particular embodiment of the present invention;

FIG. 6a shows a sectional view of the connecting part from FIG. 6 with an O-ring;

FIG. 7 shows a side view of a connecting part according to a further particular embodiment of the present invention;

FIGS. 8a and 8b show sectional views of the connection of the connecting part from FIG. 7 and the connecting part from FIG. 6a in differently fitted states;

FIG. 9 shows a sectional view of a connecting part according to a further particular embodiment of the present invention;

FIG. 9a shows a sectional view of the connecting part from FIG. 9 with an O-ring;

FIG. 10 shows a side view of a connecting part according to a further particular embodiment of the present invention;

FIGS. 11a and 11b show sectional view of the connecting part from FIG. 10 and the connecting part from FIG. 9a in differently fitted states;

FIG. 12 shows a side view of a connecting part according to a further particular embodiment of the invention;

FIG. 12a shows the view A of the connecting part from FIG. 12;

FIG. 12b shows the section B-B through the connecting part from FIG. 12;

FIG. 12C shows a sectional view of the connecting part from FIG. 12 with an O-ring;

FIG. 12d shows the section C-C through the connecting part from FIG. 12C;

FIG. 13 shows a sectional view of a connecting part according to a further particular embodiment of the present invention;

FIG. 13a shows the sectional view C-C of the connecting part from FIG. 13;

FIG. 13b shows the view B of the connecting part from FIG. 13;

FIGS. 14a and 14b show sectional views of the connection of the connecting part from FIG. 12C and the connecting part from FIG. 13 in differently fitted states;

FIG. 15 shows a side view of a connecting part of a further particular embodiment of the present invention;

FIG. 15a shows the view A of the connecting part from FIG. 15;

FIG. 15b shows the section B-B through the connecting part from FIG. 15;

FIG. 15c shows a sectional view of the connecting part from FIG. 15 with an O-ring;

FIG. 15d shows the section C-C through the connecting part from FIG. 15c;

FIG. 16 shows a sectional view of a connecting part according to a further particular embodiment of the present invention;

FIG. 16a shows the sectional view C-C of the connecting part from FIG. 16;

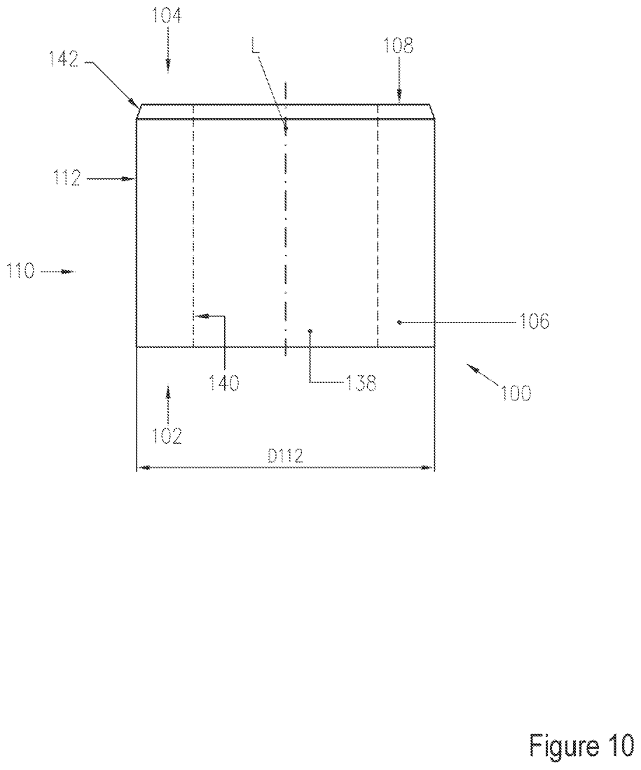

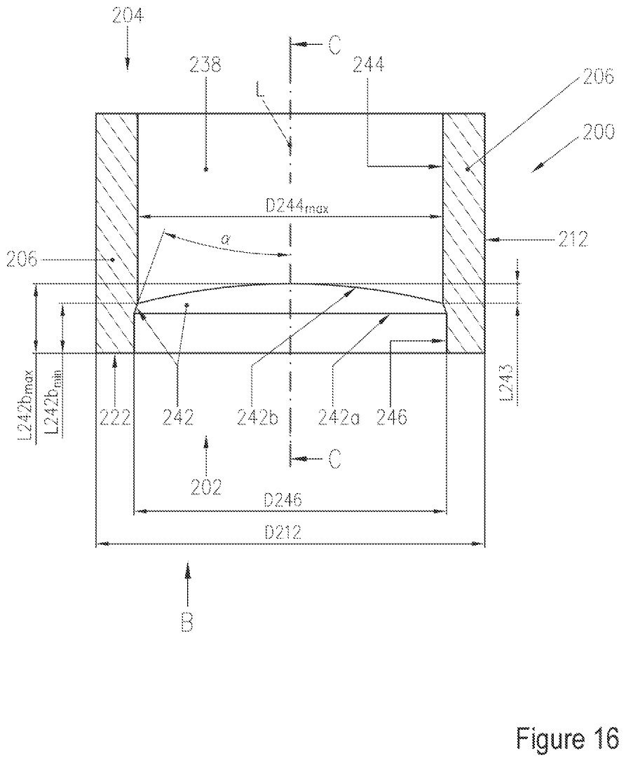

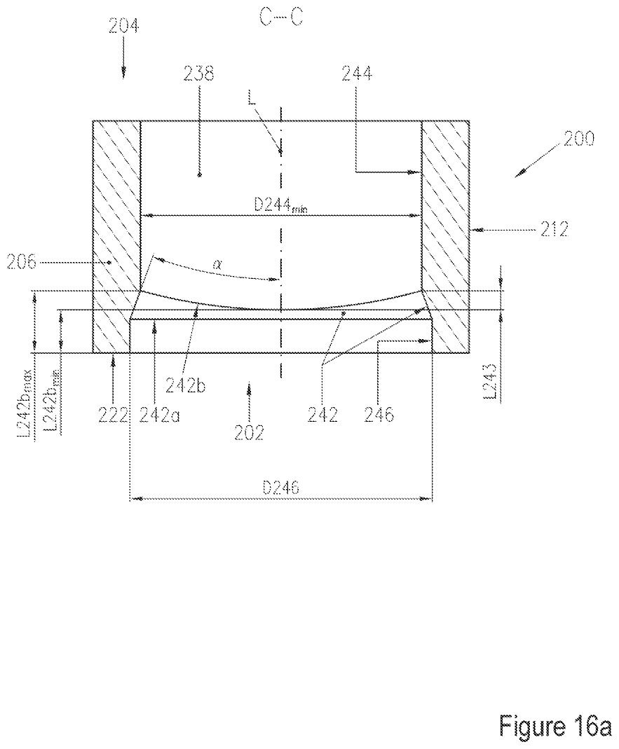

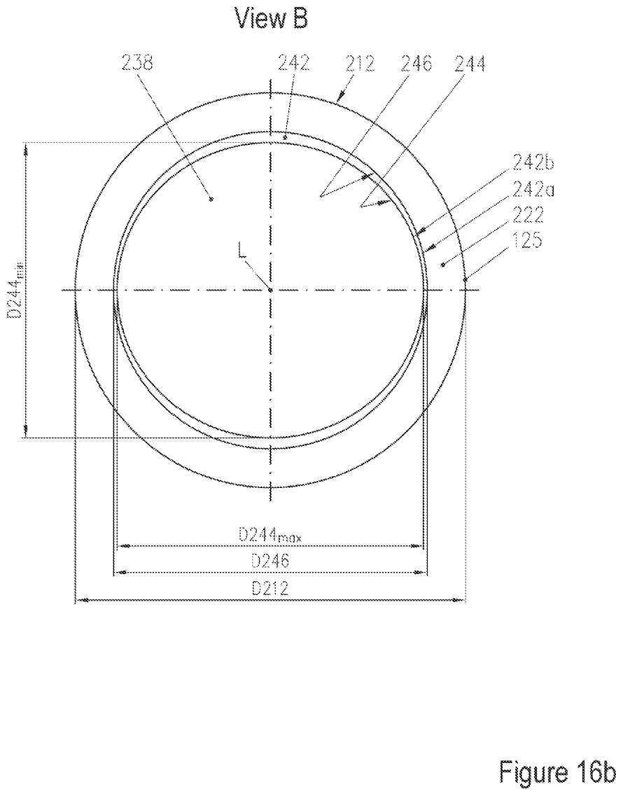

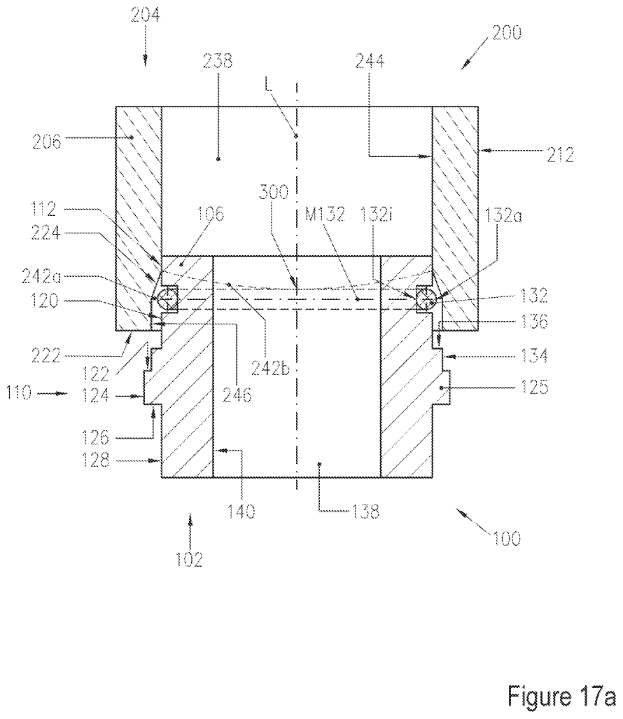

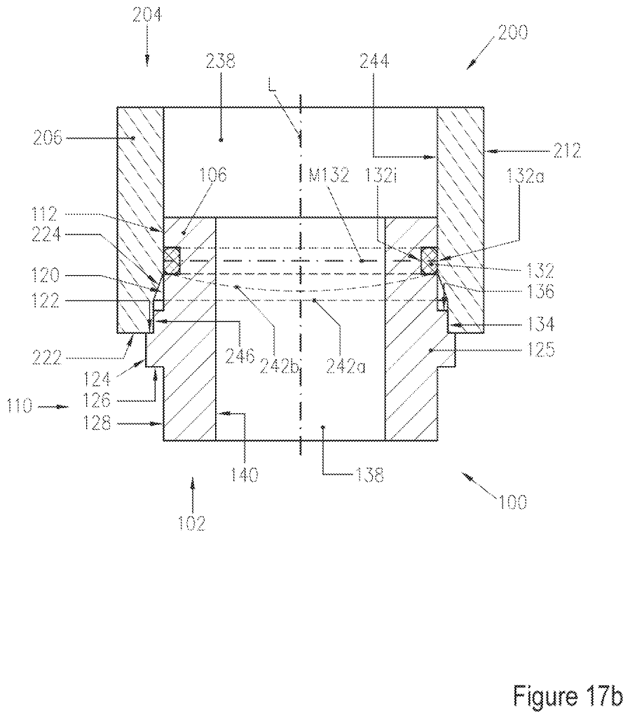

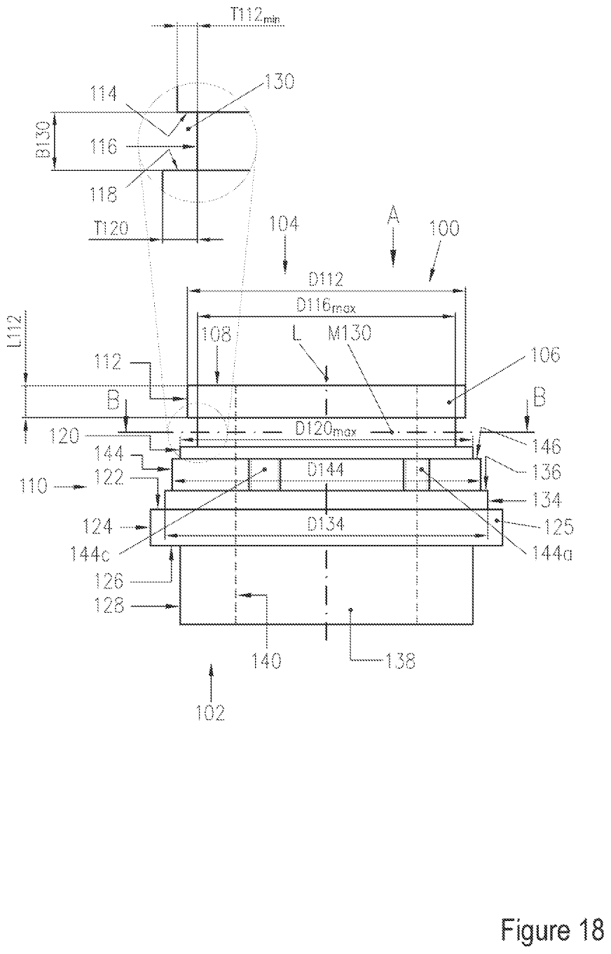

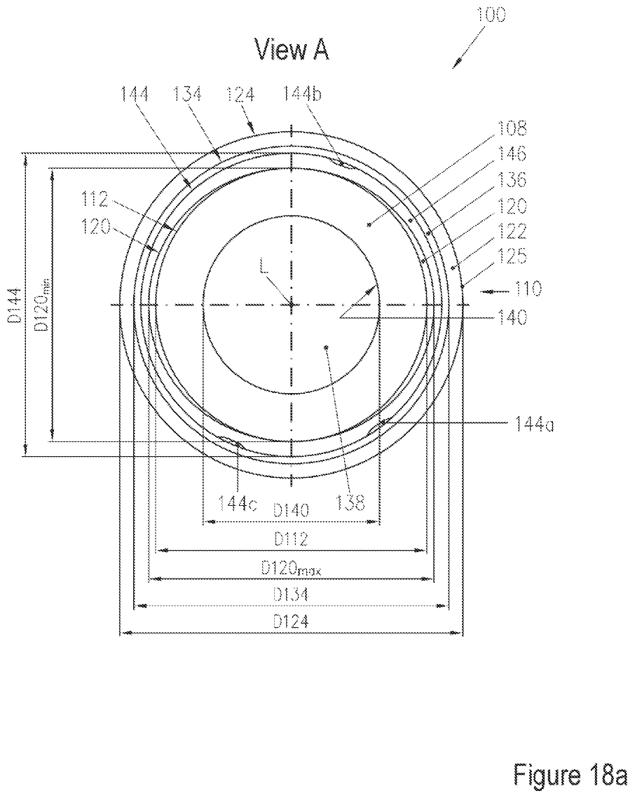

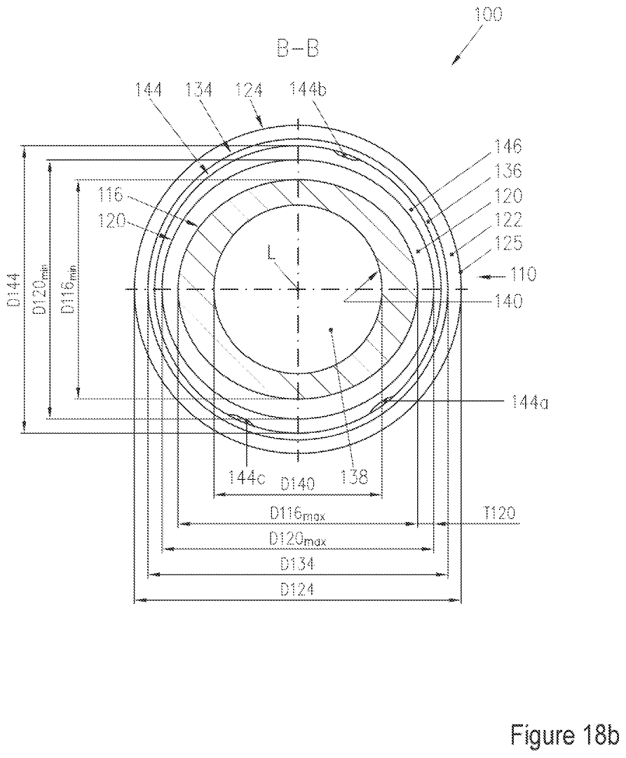

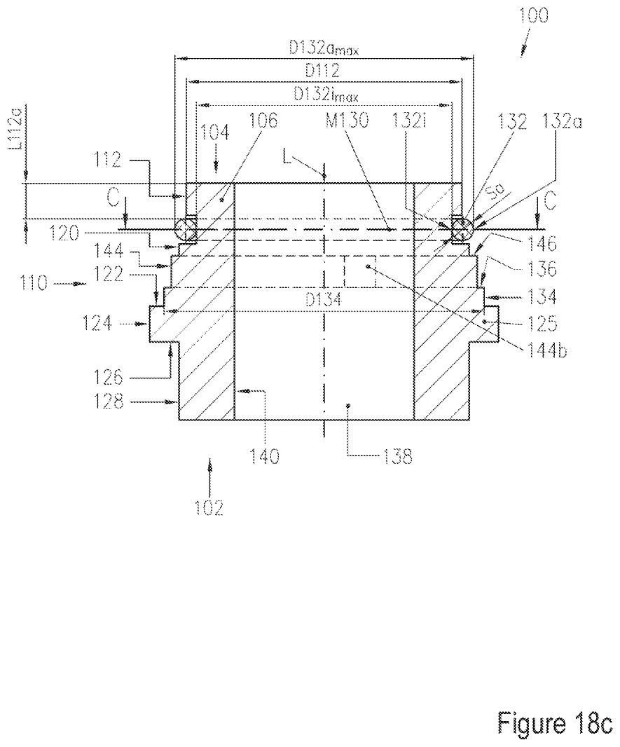

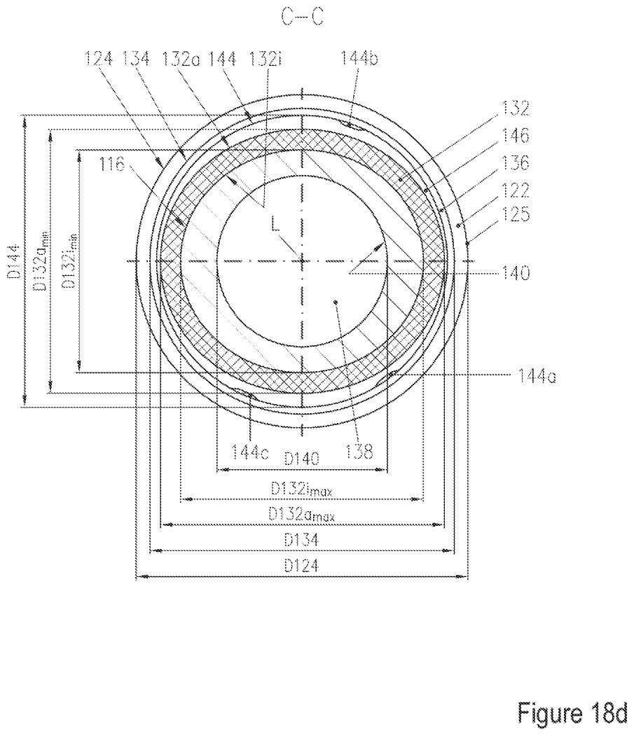

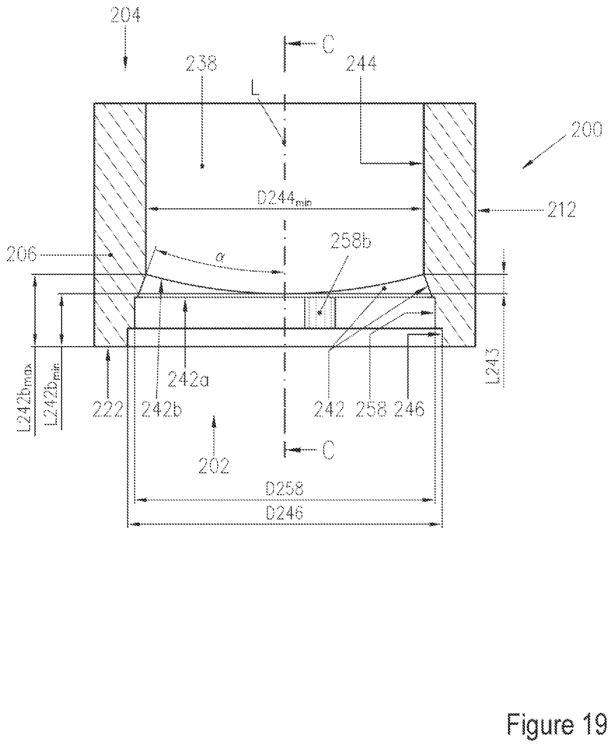

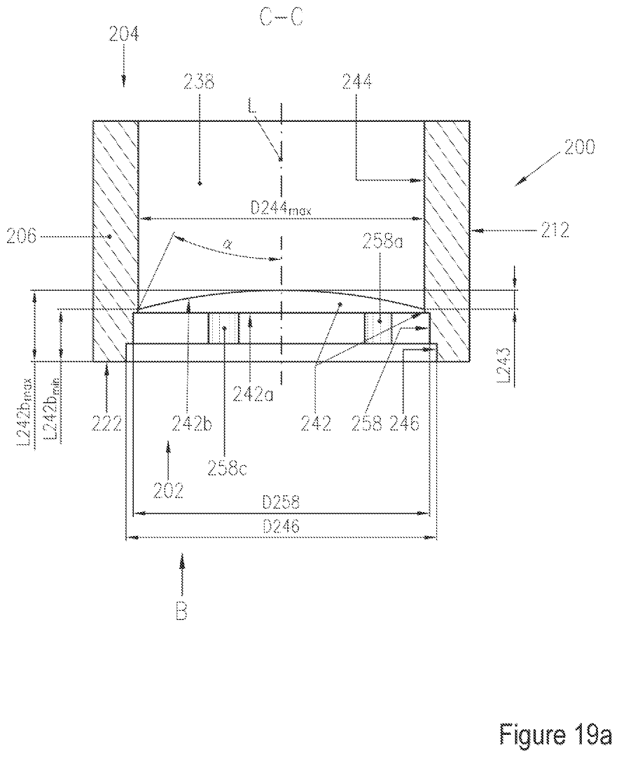

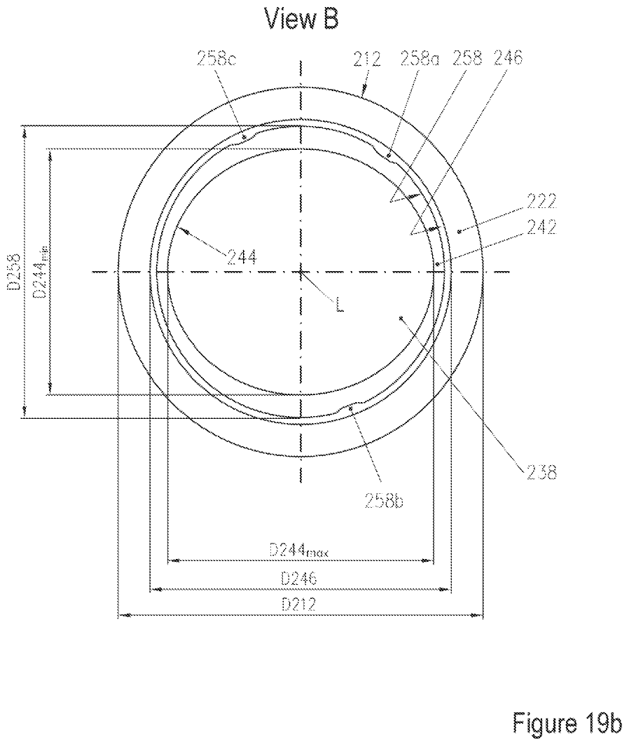

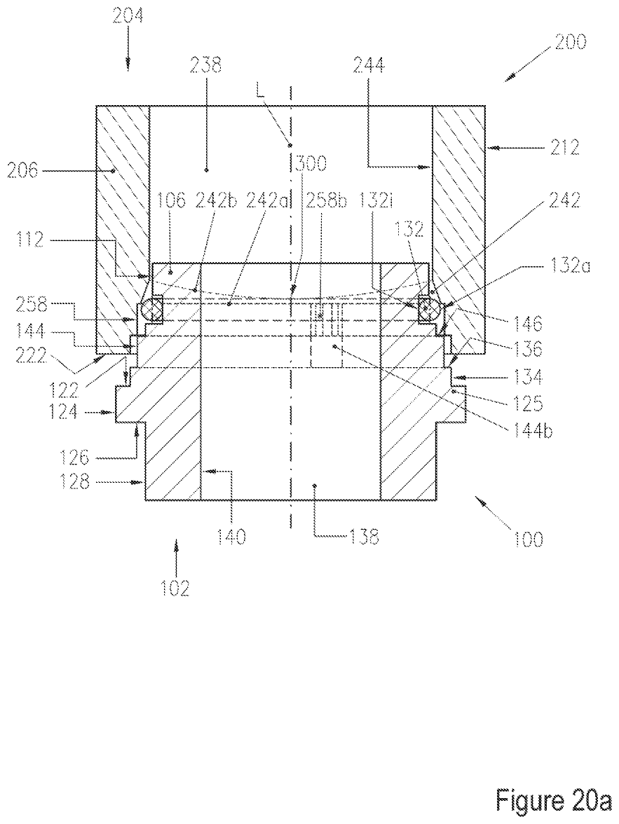

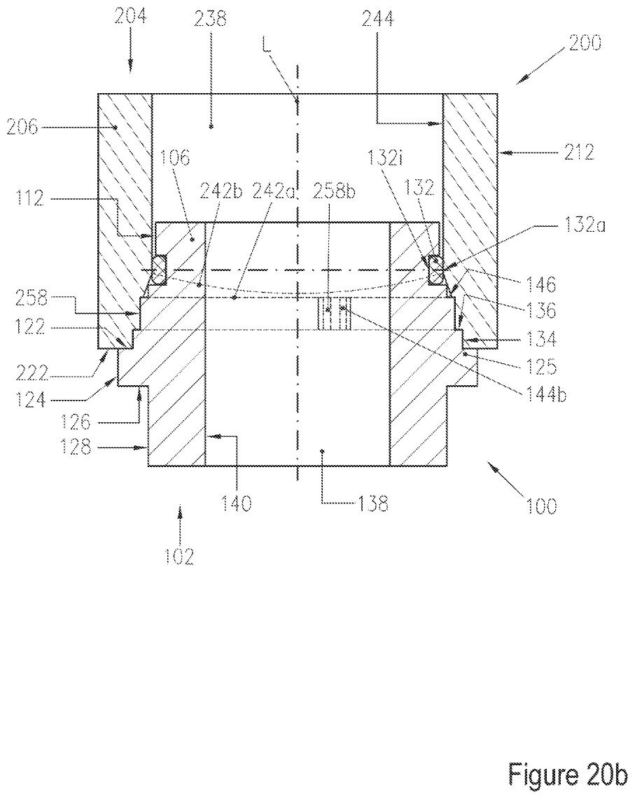

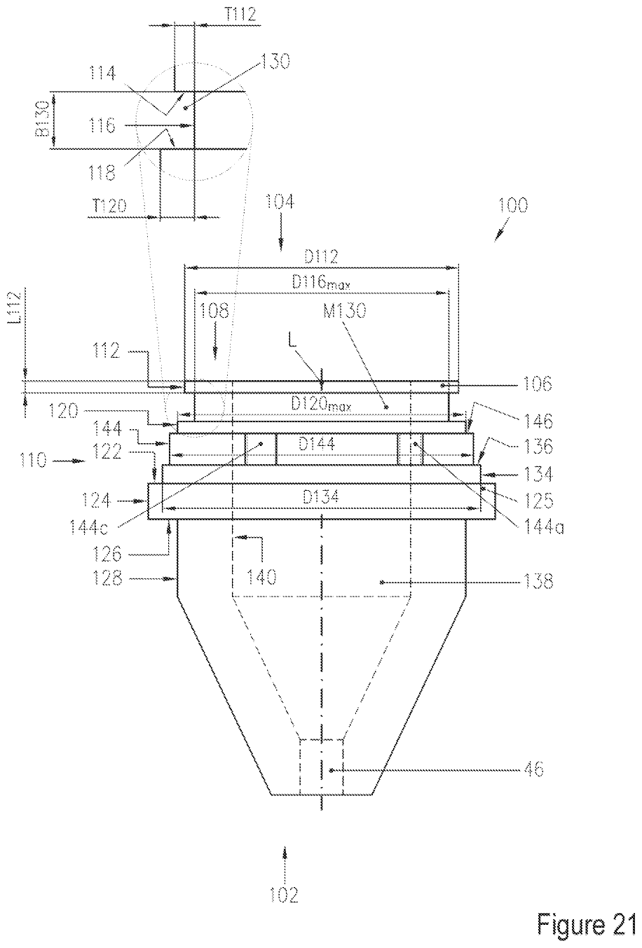

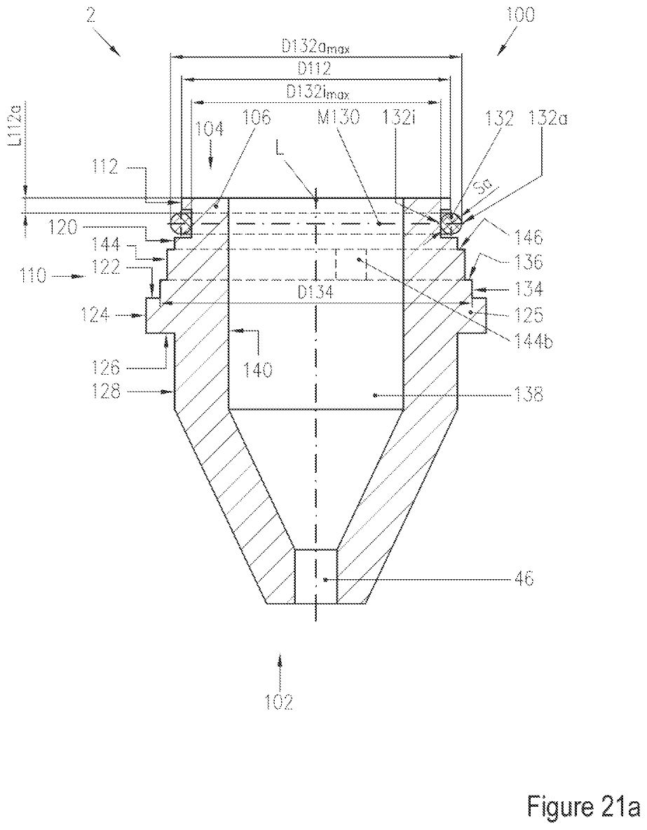

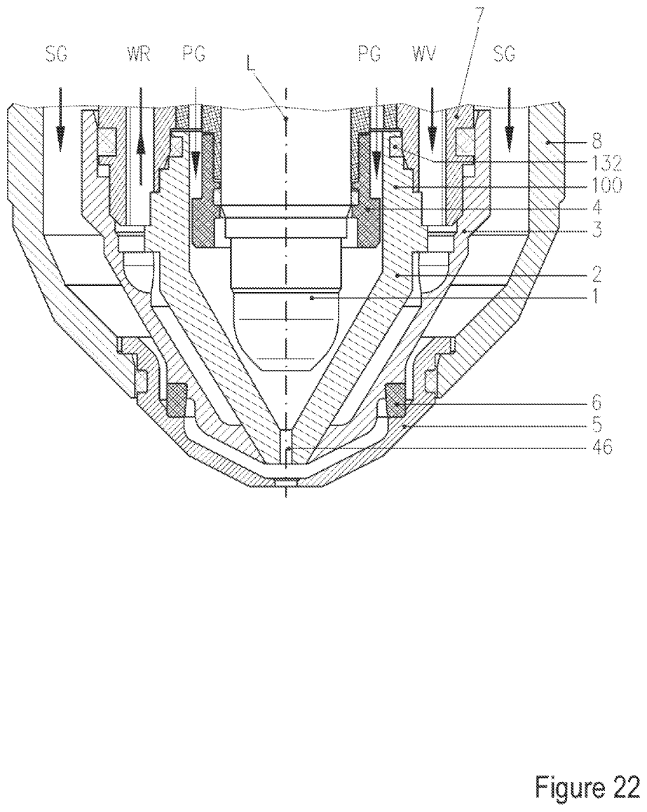

FIG. 10 shows the view B of the connecting part from FIG. 16;

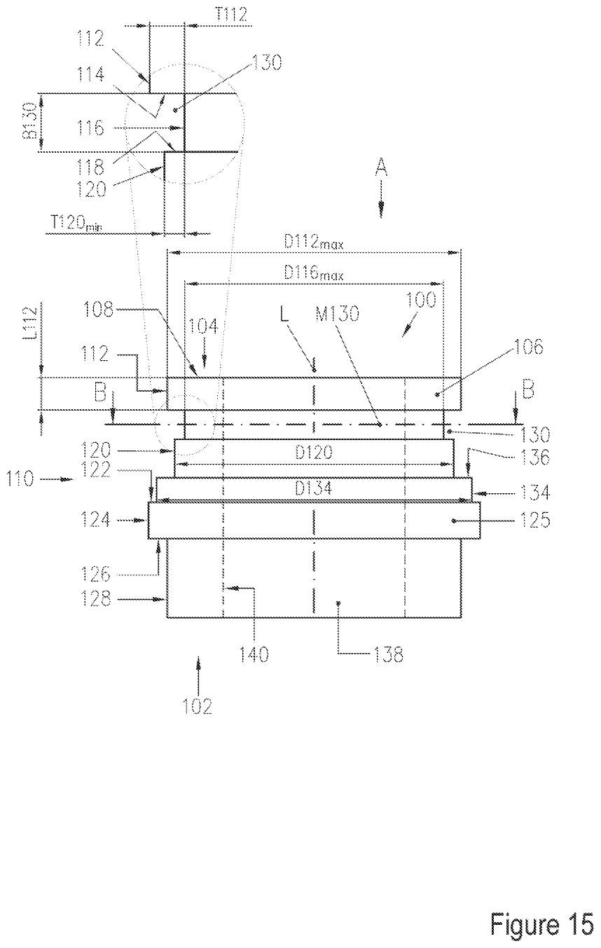

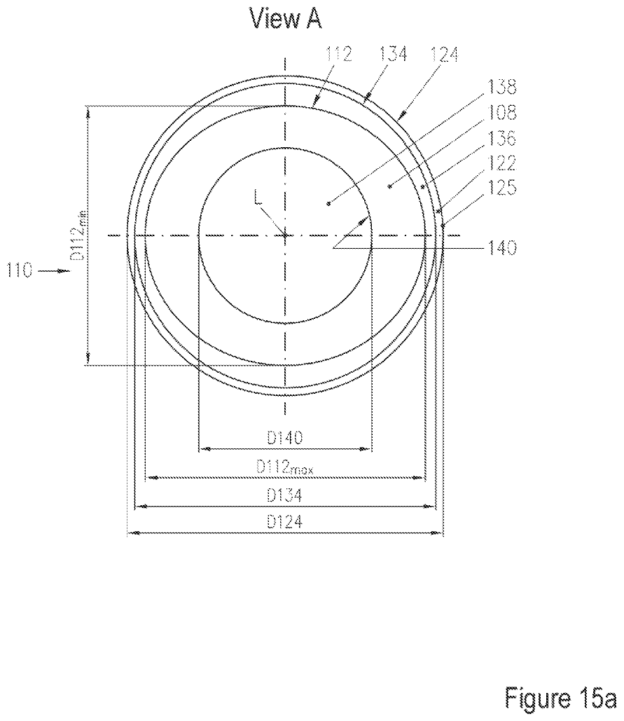

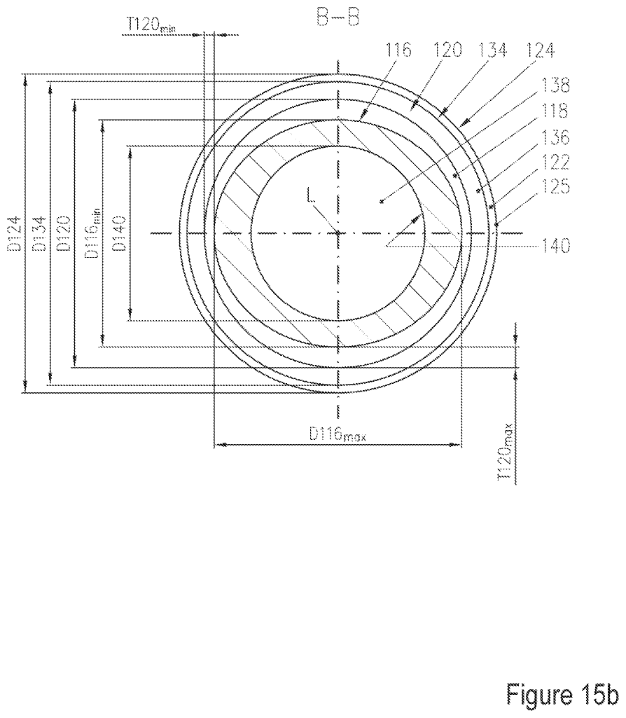

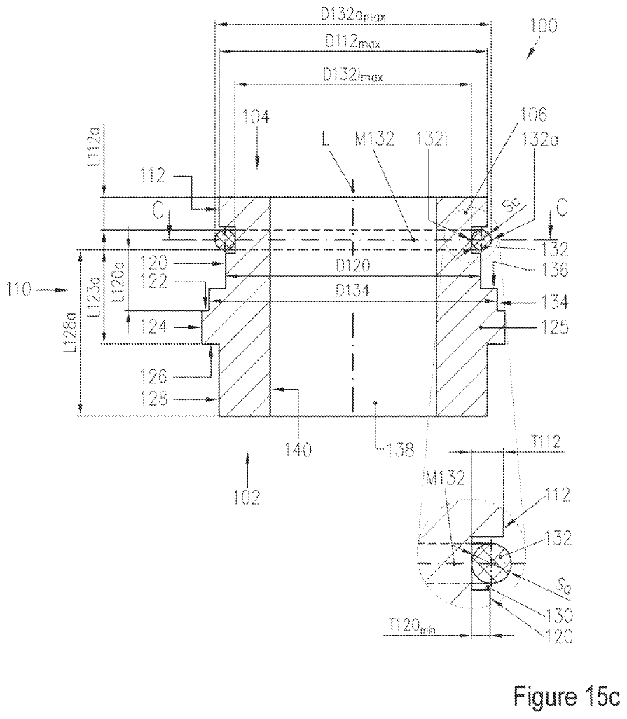

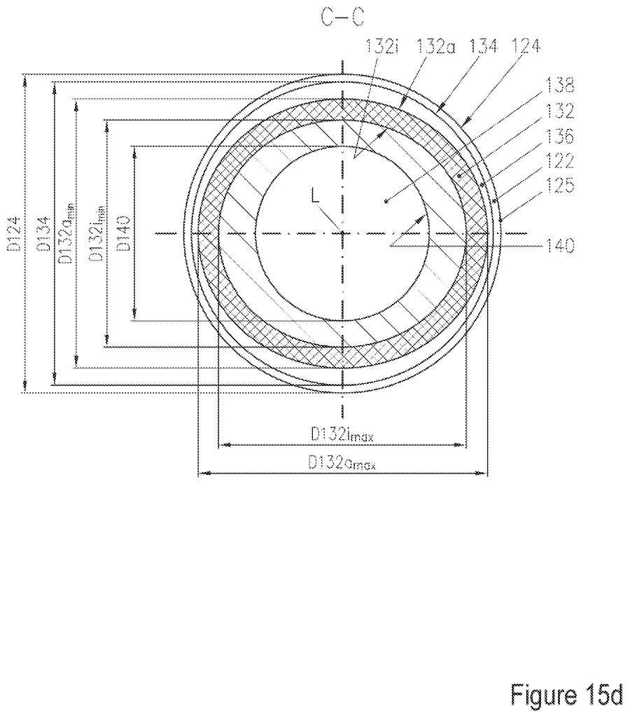

FIGS. 17a and 17b show sectional views of the connection of the connecting part from FIG. 15 or 15c and the connecting part from FIG. 16 in differently fitted states;

FIG. 18 shows a side view of a connecting part according to a further particular embodiment of the present invention;

FIG. 18a shows the view A of the connecting part from FIG. 18;

FIG. 18b shows the section B-B through the connecting part from FIG. 18;

FIG. 18c shows a sectional view of the connecting part from FIG. 18 with an O-ring;

FIG. 18d shows the section C-C through the connecting part from FIG. 18c;

FIG. 19 shows a sectional view of a connecting part according to a further embodiment of the present invention;

FIG. 19a shows the sectional view C-C of the connecting part from FIG. 19;

FIG. 19b shows the view B of the connecting part from FIG. 19a;

FIG. 20a and 20b show sectional views of the connection of the connecting part from FIG. 18c and the connecting part from FIG. 19 in differently fitted states;

FIG. 21 shows a side view of a nozzle for a plasma torch according to one particular embodiment of the present invention;

FIG. 21a shows a side view of the nozzle from FIG. 21 with an O-ring; and

FIG. 22 shows a side view of constituents of a plasma torch head according to one particular embodiment.

### DETAILED DESCRIPTION

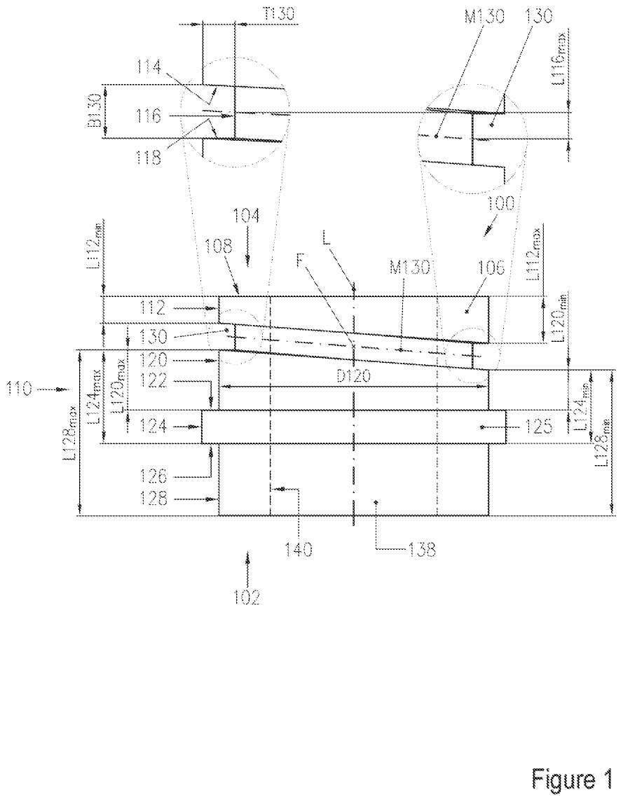

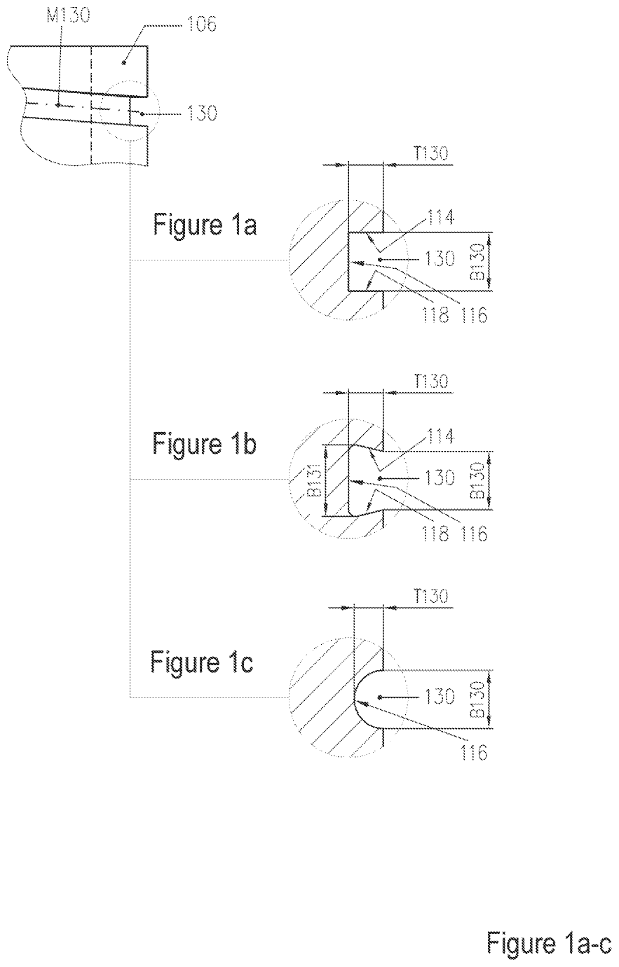

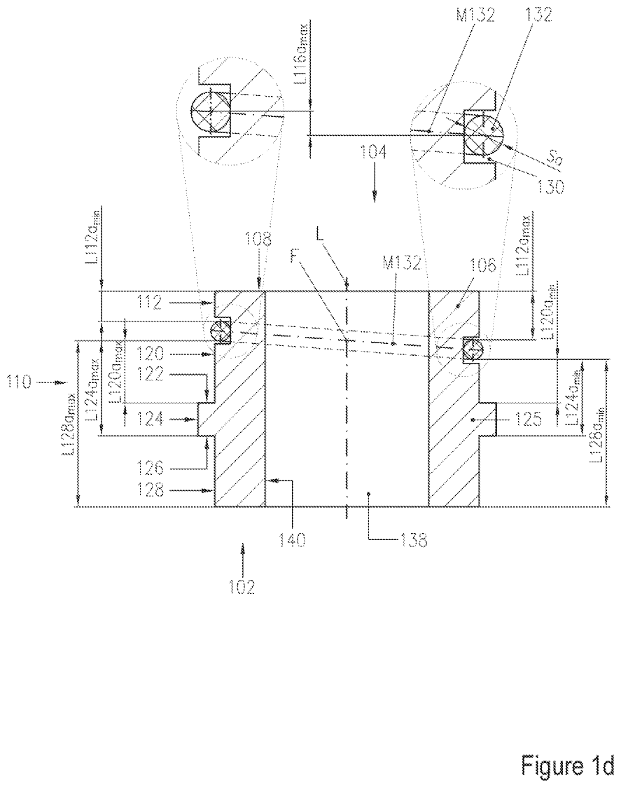

FIG. 1 shows a first connecting part 100, comprising a body 106, which extends along a longitudinal axis L, with a front end 102 and a rear end 104, with an inner face 140 and with an outer face 110, which comprises a plurality of faces 108, 112, 114, 116, 118, 120, 122, 124, 126 and 128.

The outer face 110 has an encircling slot 130. The slot 130 is bounded by lateral faces 114 (facing the rear end 104) and 118 (facing the front end 102) and a slot bottom 116. The slot 130 has a slot width B130 and a slot depth T130 and is suitable for receiving an O-ring or a profile ring. The slot 130 extends around the circumference in such a way, but exhibits, parallel to the longitudinal axis L, different distances L116 from a virtual fixed point F around the longitudinal axis with respect to a virtual centre line M130 on the slot bottom 116. A maximum distance L116ₘₐₓ is in this case half the slot width B130. In the example, the slot width is 2 mm, and so L116ₘₐₓ amounts to 1 mm.

Furthermore, a flange 125 is located on the outer face 110, said flange being bounded by the faces (outer faces) 122 (facing the rear end), 124 and 126 (facing the front end).

The rear end 104 has a face (outer face) 108.

The first lateral boundary of the slot 130, the face 114, exhibits, parallel to the longitudinal axis L, different distances L112 from the rear end 104 of the connecting part 100. The minimum distance is denoted L112ₘᵢₙ and the maximum distance is denoted L112ₘₐₓ.

The second lateral boundary of the slot 130, the face 118, exhibits, parallel to the longitudinal axis L, different distances L128 from the front end 102 of the connecting part 100, different distances L120 from the face 122 of the flange 125, and different distances L124 from the face 126 of the flange 125. The minimum distances, shown in FIGS. 1, of L128, L124 and L120 are denoted L128ₘᵢₙ, L124ₘᵢₙ and L120ₘᵢₙ and the maximum distances are denoted L128ₘₐₓ, L124ₘₐₓ and L120ₘₐₓ.

The lateral boundaries—the faces 114 and 118—of the slot 130 likewise exhibit distances, of different sizes and extending parallel to the longitudinal axis L, from the rear end 104 and from the front 102 and from the faces 122 and 126 of the flange 125. The difference between the largest and the smallest distance between one and the same lateral boundary of the slot, the side face 114 or 118, and the rear end 104 or the front end 102 or a face 122 or 126 of the flange 125 corresponds, in this example, to half the slot width of 2 mm and is 1 mm here.

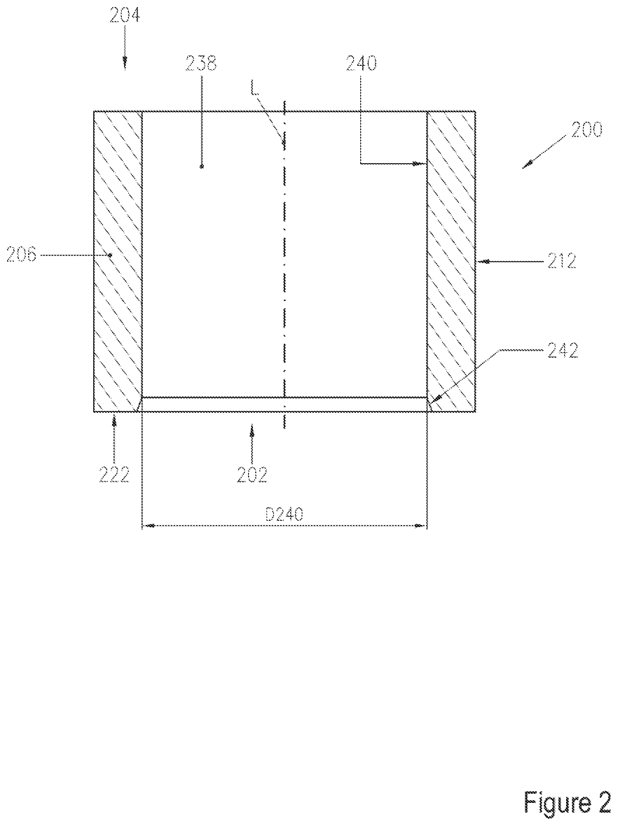

The face 122 of the flange 125 can serve as an axial stop or for positioning axially with respect to the longitudinal axis L in another connecting part, for example a connecting part 200 shown in FIG. 2.

The outer faces 112, 120 and 124 can serve for centring radially with respect to the longitudinal axis L when the connecting part 100 is inserted for example into the connecting part 200 shown in FIG. 2.

The connecting part 100 has, on the inside, along the longitudinal axis L, a continuous opening 138 with an inner face 140. A fluid can flow through this opening 138 in the installed state.

Figures is to ie show, by way of example, different slot shapes of the slot 130; a rectangular slot in FIG. 1a, what is known as a trapezoidal slot in FIG. 1b and a round slot in FIG. 1c. In the middle of the slot bottom 116, a virtual centre line M130 of the slot 130 extends in an encircling manner. This virtual centre line also exhibits different distances, around the circumference, from the fixed point F.

FIG. 1d shows the connecting part 100 from FIG. 1 with an O-ring 132 in the slot 130.

In this example, the O-ring 132 has a cord size Sa of 1.5 mm. In the middle of the cord, there is a virtual centre line M132. The O-ring 132 extends around the circumference in the slot 130. However, a virtual centre line M132 exhibits different distances L116a, parallel to the longitudinal axis L, around the longitudinal axis L, from a fixed point F. The maximum distance L116aₘₐₓ amounts, in this example, to ⅔ of the cord size Sa. In the example, the cord size Sa is 1.5 mm, and so the maximum distance L116aₘₐₓ amounts to 1 mm.

The outer face, facing in the direction of the rear end 104, of the O-ring 132 exhibits, parallel to the longitudinal axis L, different distances L112a from the rear end 104. The minimum distance is denoted L112aₘᵢₙ and the maximum distance is denoted L112aₘₐₓ.

The outer face, facing in the direction of the front end 102, of the O-ring 132 exhibits, parallel to the longitudinal axis L, different distances L128a, from the front end 102, different distances L120a from the face 122 of the flange 125 and different distances L124a from the face 126 of the flange 125. The minimum distances, shown in FIG. 1d, of L128a, L124a and L120a are denoted L128aₘᵢₙ, L124aₘᵢₙ and L120aₘᵢₙ and the maximum distances are denoted L128aₘₐₓ, L124aₘₐₓ and L120aₘₐₓ.

The respective outer faces, facing the closer end, of the O-ring 132 thus exhibit, parallel to the longitudinal axis L, axial distances of different sizes from the rear end 104 and from the front end 102 and from the faces 122 and 126 of the flange 125.

The difference between the largest and the smallest distance between the outer face, facing the rear end 104, of the O-ring 132 and the rear end 104 and the difference between the largest and the smallest distance between the outer face, facing the front end 102, of the O-ring 132 and the front end 102 or a face 122 or 126 of the flange corresponds, in this example, to ⅔ of the cord size Sa, in this case 1 mm.

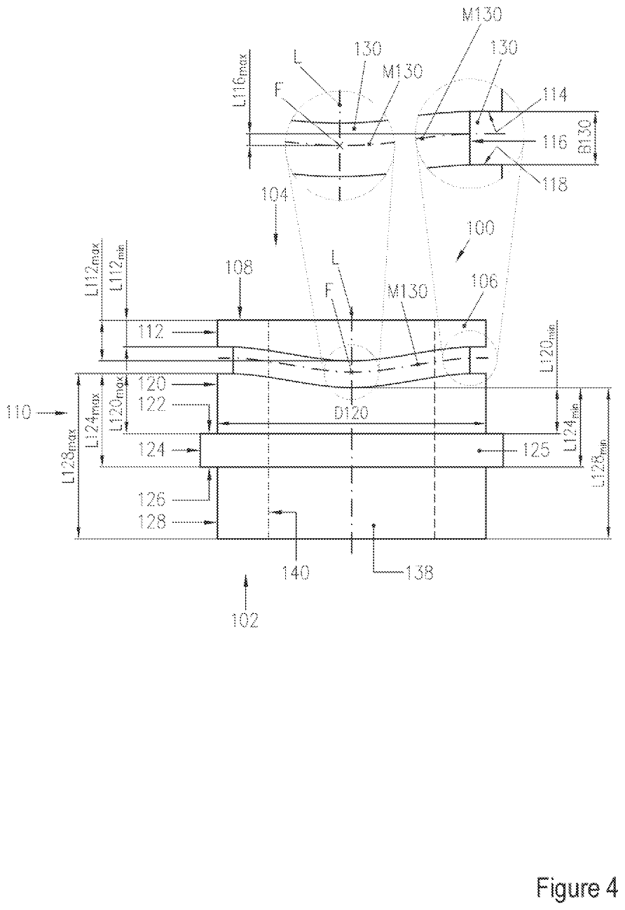

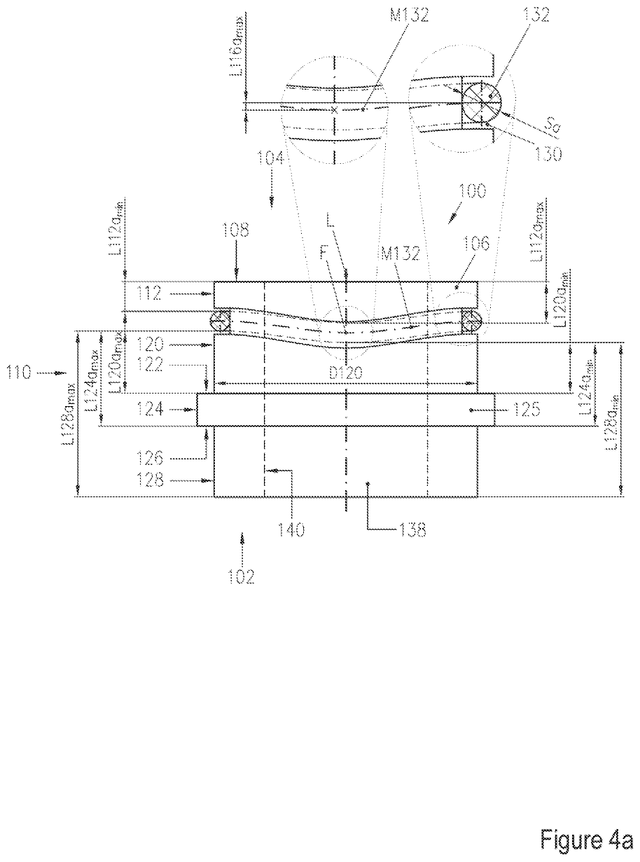

FIG. 2 shows, by way of example, a second connecting part 200, into which the connecting part wo from FIG. 1d and FIG. 4a can be plugged or fitted. It comprises a body 206, which extends along a longitudinal axis L, with a front end 202 and a rear end 204, with an outer face 212 and an inner face 240. Between the front end 202 and the rear end 204 there extends an opening 238. Located at the front end 202 is a face 222, which can serve as a stop face for the face 122 of the connecting part boo from FIG. 1, and a chamfer 242, which makes it easier to introduce the connecting part 100 into the opening 238 in the connecting part 200.

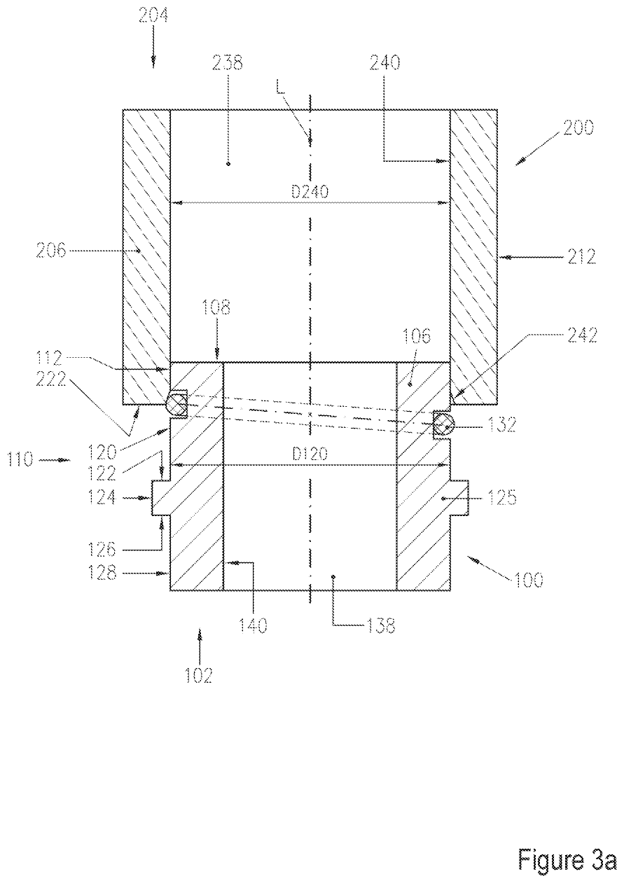

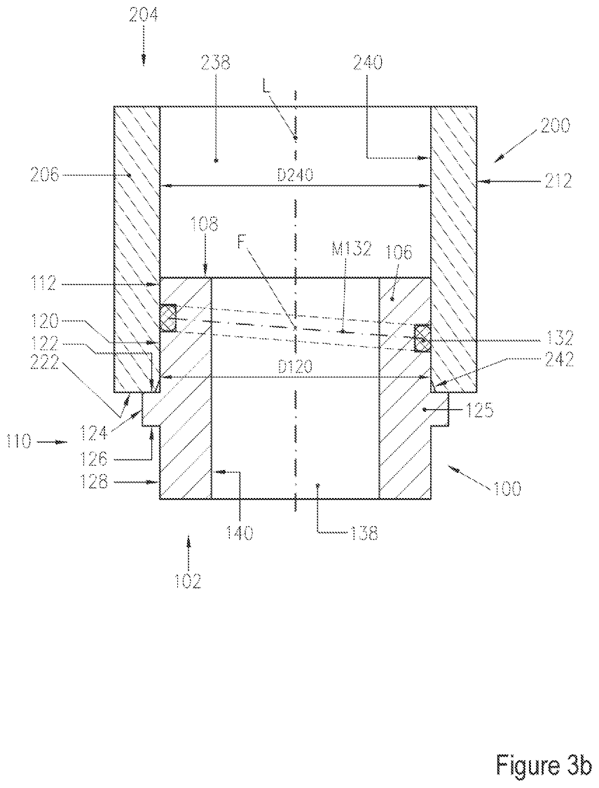

FIGS. 3a and 3b show, by way of example, the connection of the first connecting part 100 from FIG. 1d and the second connecting part 200 from FIG. 2 in differently fitted states.

In FIG. 3a, the O-ring 132 is just starting to make contact with the surface of the chamfer 242 at one point (visible on the left). Here, an advantage of the invention becomes apparent. It is not necessary for the O-ring 132 to be deformed around its entire circumference right at the start of fitting, rather, it starts initially at one point and then “travels” around the circumference. As a result, the force required is reduced and plugging together is made easier.

FIG. 3b shows, by way of example, the fully fitted or plugged-together connecting parts 100 and 200. The connecting point or line is sealed by the plugging of the first connecting part 100 into the second connecting part 200 and the O-ring 132 in combination with the inner face 240 for a fluid that can flow through the inner openings 138 and 238. The connecting parts 100 and 200 are aligned radially with respect to the longitudinal axis L via a tight tolerance, for example a fit H7/h6 or H7/h7 according to DIN ISO 286, of the inner face 240 with a diameter D240 with respect to the outer face 120 with an outside diameter D120. The axial alignment with respect to the longitudinal axis L of the connecting parts with respect to one another occurs by way of contact of the face 122 of the first connecting part 100 and the face 222 of the second connecting part 200.

Thus, easy fitting and clear axial and radial positioning with a low tolerance with a simultaneously sealed connection are possible.

FIG. 4 in turn shows, by way of example, a connecting part 100, similar to FIG. 1. In contrast to FIG. 1, the slot 130 exhibits, around the circumference, not just one maximum distance, extending parallel to the longitudinal axis L, and one minimum distance, but a plurality of maximum and minimum distances. Specifically, this means, in this example:

The slot 130 extends around the circumference. A virtual centre line M130 on the slot bottom 116, however, exhibits in turn different distances L116, parallel to the longitudinal axis L, around the longitudinal axis L, from a virtual fixed point F. A maximum distance L116ₘₐₓ, which, in the example shown here, occurs twice, and moreover is equidistant in this example, around the circumference, amounts here to half the slot width B130. In the example, the slot width is 2 mm, and so L116ₘₐₓ amounts to 1 mm.

A first lateral boundary of the slot 130, the face 114, exhibits, parallel to the longitudinal axis L, different distances L112 from the rear end 104. A minimum distance is denoted L112ₘᵢₙ and a maximum distance is denoted L112ₘₐₓ. The minimum and maximum distances are in this case each present twice.

A second lateral boundary of the slot 130, the face 118, exhibits, parallel to the longitudinal axis L, different distances L128 from the front end 102, different distances L120 from the face 122 of the flange 125 and different distances L124 from the face 126 of the flange 125. The minimum distances, shown in FIGS. 4, of L128, L124 and L120 are denoted L128ₘᵢₙ, L124ₘᵢₙ and L120ₘᵢₙ and the maximum distances are denoted L128ₘₐₓ, L124ₘₐₓ and L120ₘₐₓ. The minimum and maximum distances are in this case each present twice.

The lateral boundaries—the faces 114 and 118—of the slot 130 likewise exhibit distances, of different sizes and extending parallel to the longitudinal axis L, from the rear end 104 and from the front end 102 and from the faces 122 and 126 of the flange 125. It is, of course, possible for more than two minimum and maximum distances to be realized.

The difference between the largest and the smallest distance between one and the same boundary of the slot, the side face 114, 118 and the rear end 104 or the front end 102 or a face 122 or 126 of the flange corresponds in this example to half the slot width of 2 mm and is 1 mm here.

The face 122 of the flange 125 can serve as an axial stop or for positioning axially with respect to the longitudinal axis L in another connecting part, for example the connecting part 200 from FIG. 2.

The faces 112, 120 and 124 are outer faces and can serve for centring radially with respect to the longitudinal axis L when the connecting part wo is inserted for example into the connecting part 200 shown in FIG. 2.

The connecting part wo has, on the inside, along the longitudinal axis L, a continuous opening 138 with an inner face 140. A fluid can flow through this opening 138 in the installed state.

FIG. 4a shows, by way of example, the connecting part from FIG. 4 with an O-ring 132 in the slot 130.

In this example, the O-ring 132 has a cord size Sa of 1.5 mm. In the middle of the cord, there is a virtual centre line M132. The O-ring 132 extends around the circumference in the slot 130. However, a virtual centre line M132 exhibits different distances L116a, parallel to the longitudinal axis L, around the longitudinal axis L, from a fixed point F. The maximum distance L116aₘₐₓ amounts, in this example, to ⅔ of the cord size Sa. In the example, the cord size Sa is 1.5 mm, and so the maximum distance L116aₘₐₓ amounts to 1 mm.

The outer face, facing in the direction of the rear end 104, of the O-ring 132 exhibits, parallel to the longitudinal axis L, different distances L112a from the rear end 104. The minimum distance is denoted L112aₘᵢₙ and the maximum distance is denoted L112aₘₐₓ.

The outer face, facing in the direction of the front end 102, of the O-ring 132 exhibits, parallel to the longitudinal axis L, different distances L128a, from the front end 102, different distances L120a from the face 122 of the flange 125 and different distances L124a from the face 126 of the flange 125. The minimum distances, shown in FIG. 4a, of L128a, L124a and L120a are denoted L128aₘᵢₙ, L124aₘᵢₙ and L120aₘᵢₙ and the maximum distances are denoted L128aₘₐₓ, L124aₘₐₓ and L120aₘₐₓ.

The respective outer faces, facing the closer end, of the O-ring 132 thus exhibit, parallel to the longitudinal axis L, distances of different sizes from the rear end 104 and from the front end 102 and from the faces 122 and 126 of the flange 125.

The difference between the largest and the smallest distance between the outer face, facing the rear end 104, of the O-ring 132 and the rear end 104 and the difference between the largest and the smallest distance between the outer face, facing the front end 102, of the O-ring 132 and the front end 102 or a face 122 or 126 of the flange corresponds, in this example, to ⅔ of the cord size Sa, in this case 1 mm.

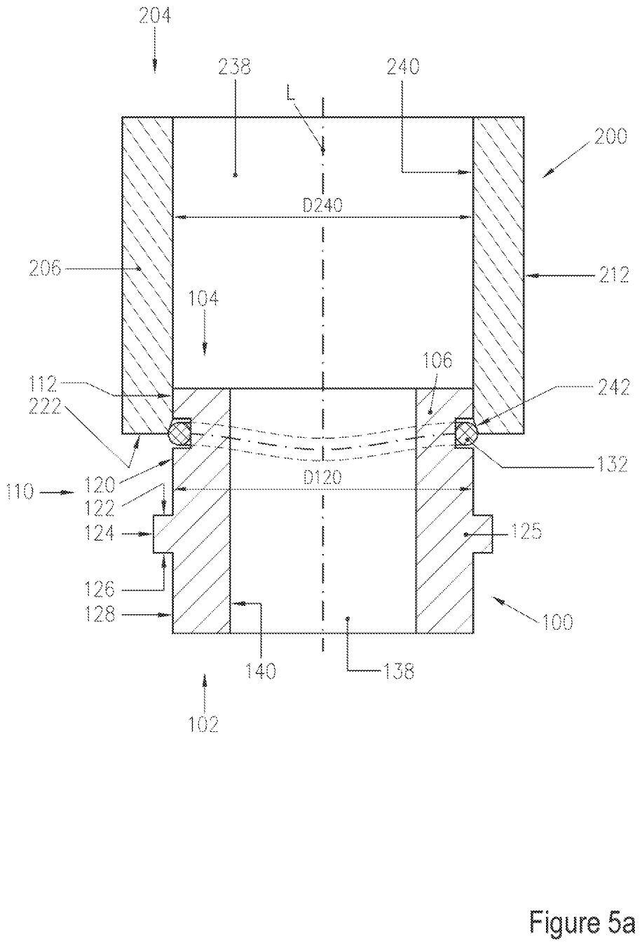

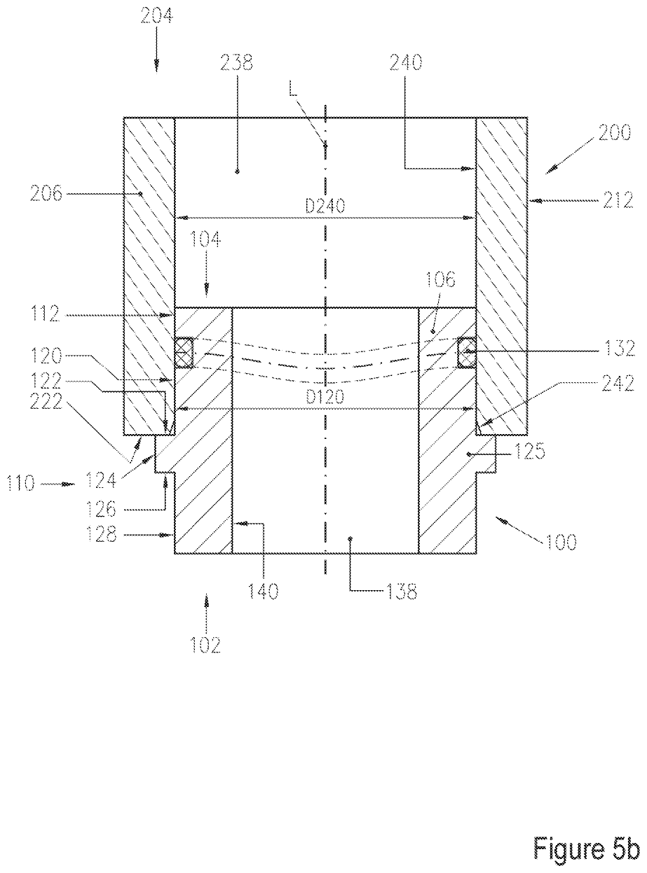

FIGS. 5a and 5b show, by way of example, the connection of the first connecting part 100 from FIG. 4a and the second connecting part 200 from FIG. 2 in differently fitted states.

In FIG. 5a, the O-ring 132 is just starting to make contact with the surface of the chamfer 232 at two points (visible on the left and right). Here, an advantage of the invention becomes apparent. It is not necessary for the O-ring 132 to be deformed around its entire circumference right at the start of fitting, rather, in this case, it starts at two points that are arranged on opposite sides around the circumference, and, depending on the fitted state, the deformation takes place gradually around the entire circumference. As a result, the force required is reduced and plugging together is made easier. An advantage compared with FIG. 3 is that, as a result of the O-ring meeting the chamfer 242 at two points, at the same time the risk of canting is reduced.

What is advantageous in terms of countering canting is that the start of the deformation is simultaneous at at least three points.

A drawback is that, as the number of contact points at the start of fitting increases, more force is again required for fitting.

FIG. 5b shows, by way of example, the fully fitted or plugged-together connecting parts 100 and 200. The connecting point or line is sealed by the plugging of the first connecting part 100 into the second connecting part 200 and the O-ring 132 in combination with the inner face 240 for a fluid that can flow through the inner openings 138 and 238. The connecting parts 100 and 200 are aligned radially with respect to the longitudinal axis L via a tight tolerance, for example a fit H7/h6 or H7/h7 according to DIN ISO 286, of the inner face 240 with the diameter D240 with respect to the outer face 120 with the outside diameter D120. The axial alignment with respect to the longitudinal axis L of the connecting parts with respect to one another occurs by way of contact of the face 122 of the first connecting part 100 and the face 222 of the second connecting part 200.

Thus, easy fitting and clear axial and radial positioning with respect to the longitudinal axis L with a low tolerance with a simultaneously sealed connection of the connecting parts are possible.

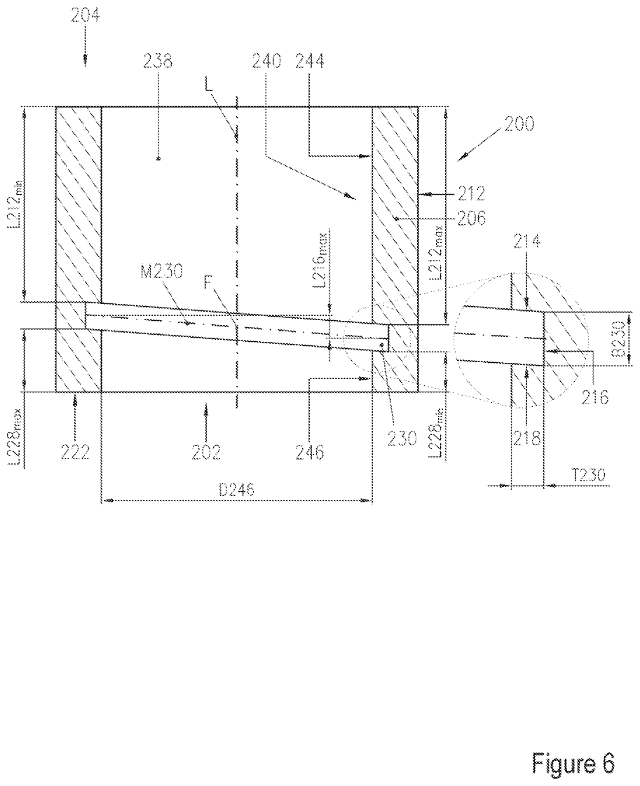

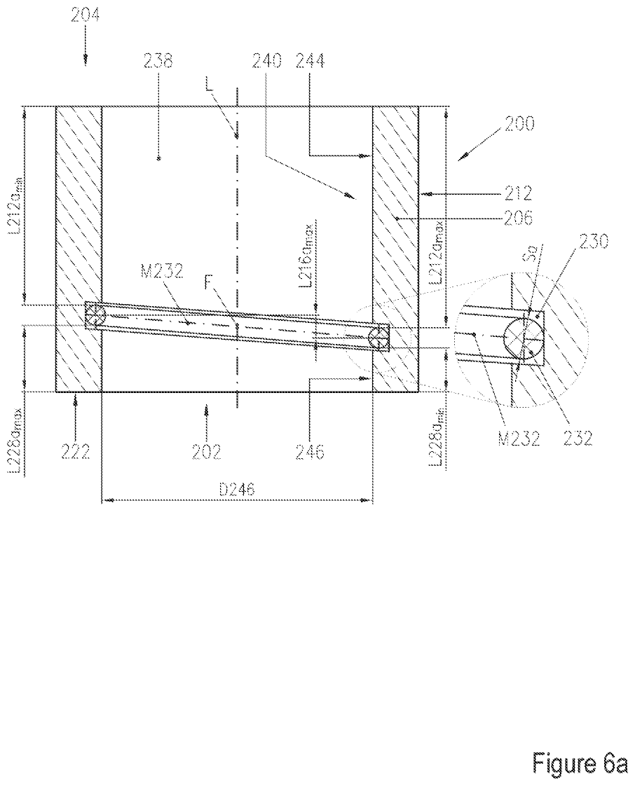

FIG. 6 shows a second connecting part 200, comprising a body 206, which extends along a longitudinal axis L, with a front end 202 and a rear end 204, an outer face 212 and with an inner face 240, which comprises a plurality of faces 214, 216, 218, 244 and 246.

The inner face 240 has an encircling slot 230. The slot 230 is bounded by lateral faces 214 and 218 and a slot bottom 216. The slot 230 has a slot width B230 and a slot depth T230 and is suitable for receiving an O-ring or a profile ring. The slot 230 extends around the circumference. However, a virtual centre line M230 on the slot bottom 216 exhibits different distances L216, parallel to the longitudinal axis L, around the longitudinal axis L, from a fixed point F. A maximum distance L216ₘₐₓ amounts, in this example, to half the slot width B230. In this example, the slot width is 2 mm, and so L216ₘₐₓ amounts to 1 mm.

The first lateral boundary of the slot 230, the face 214, exhibits, parallel to the longitudinal axis L, different distances L212 from the rear end 204 of the connecting part 200. The minimum distance is denoted L212ₘᵢₙ and the maximum distance is denoted L212ₘₐₓ.

The second lateral boundary of the slot 230, the face 218, exhibits, parallel to the longitudinal axis L, different distances L228 from the front end 202 of the connecting part 200. The minimum distance is denoted L228ₘᵢₙ and the maximum distance is denoted L228ₘₐₓ.

The lateral boundaries—the faces 214 and 218—of the slot 230 thus exhibit distances, of different sizes and extending parallel to the longitudinal axis L, from the rear end 204 and from the front end 202.

The difference between the largest and the smallest distance between one and the same boundary of the slot, the lateral face 214 or 218 and the rear end 204 or the front end 202 corresponds, in this example, to half the slot width of 2 mm and is 1 mm here.

FIG. 6a shows, by way of example, the connecting part 200 from FIG. 6 with an O-ring 232 in the slot 230.

In this example, the O-ring 232 has a cord size Sa of 1.5 mm. In the middle of the cord, there is a virtual centre line M232. The O-ring 232 extends around the circumference in the slot 130. However, a virtual centre line M232 exhibits different distances L216a, parallel to the longitudinal axis L, around the longitudinal axis L, from a fixed point F. The maximum distance L216aₘₐₓ amounts, in this example, to ⅔ of the cord size Sa. In the example, the cord size Sa is 1.5 mm, and so the maximum distance L216aₘₐₓ amounts to 1 mm.

The outer face, facing in the direction of the rear end 204, of the O-ring 232 exhibits, parallel to the longitudinal axis L, different distances L212a from the rear end 204. The minimum distance is denoted L212aₘᵢₙ and the maximum distance is denoted L212aₘₐₓ.

The outer face, facing in the direction of the front end 202, of the O-ring 232 exhibits, parallel to the longitudinal axis L, different distances L228a from the front end 202. The minimum distance is denoted L228aₘᵢₙ and the maximum distance is denoted L228aₘₐₓ.

The respective outer faces, facing the closer end, of the O-ring 232 thus exhibit, parallel to the longitudinal axis L, axial distances of different sizes from the rear end 204 and from the front end 202.

The difference between the largest and the smallest distance between the outer face, facing the rear end 204, of the O-ring 232 and the rear end 204 and the difference between the largest and the smallest distance between the outer face, facing the front end 202, of the O-ring 232 and the front end 202 corresponds, in this example, to ⅔ of the cord size Sa, in this case 1 mm.

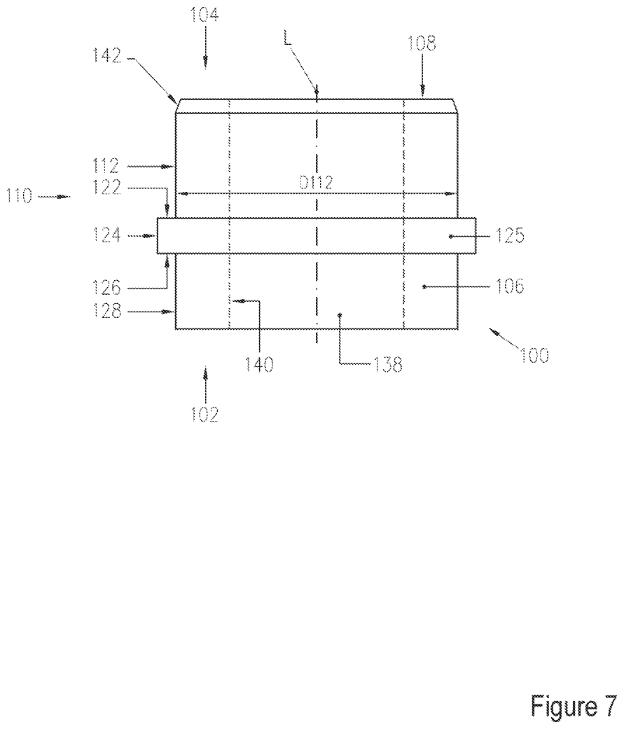

FIG. 7 shows, by way of example, a first connecting part boo, which can be plugged or fitted into the connecting part 200 from FIG. 6a. It comprises a body 106, which extends along a longitudinal axis L, with a front end 102 and a rear end 104, with an outer face 110, which comprises a plurality of faces 112, 122, 124, 126 and 128, and an inner face 140. Between the front end 102 and the rear end 104 there extends an opening 138. Located at the rear end 104 is a chamfer 142, which makes it easier to introduce the connecting part 100 into the opening 238 in the connecting part 200.

Furthermore, a flange 125 is located on the outer face 110, said flange being bounded by the faces (outer faces) 122, 124 and 126.

The rear end 104 has an outer face 108.

The outer face 122 of the flange 125 can serve as an axial stop or for positioning axially with respect to the longitudinal axis L for example in the connecting part 200 shown in FIG. 6a.

The outer face 112 can serve for centring radially with respect to the longitudinal axis L when the connecting part is inserted for example into the connecting part 200 shown in FIG. 6.

The connecting part 100 has, on the inside, along the longitudinal axis L, a continuous opening 138 with an inner face 140. A fluid can flow through this opening 138 in the installed state.

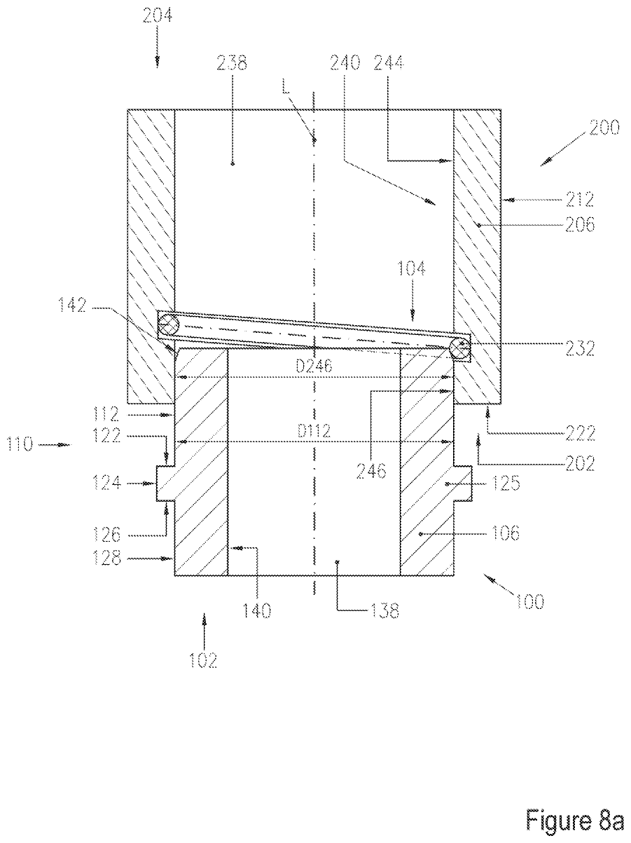

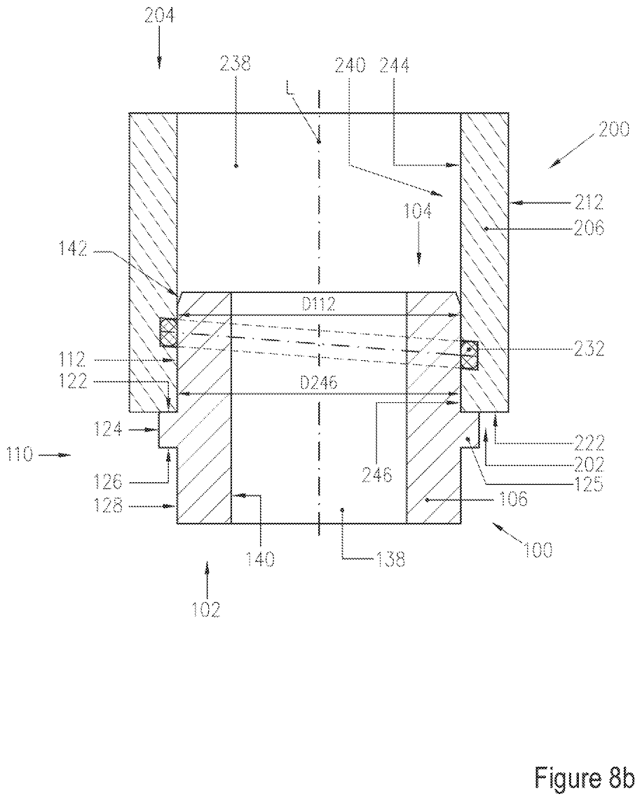

FIGS. 8a and 8b show, by way of example, the connection of the first connecting part 100 from FIG. 7 and the second connecting part 200 from FIG. 6a in differently fitted states.

In FIG. 8a, the O-ring 132 is just starting to make contact with the surface of the chamfer 142 at one point (visible on the right). Here, an advantage of the invention becomes apparent. It is not necessary for the O-ring 132 to be deformed around its entire circumference right at the start of fitting, rather, it starts initially at one point and then “travels” around the circumference. As a result, the force required is reduced and plugging together is made easier.

FIG. 8b shows, by way of example, the fully fitted or plugged-together connecting parts 100 and 200. The connecting point or line is sealed by the plugging of the first connecting part 100 into the second connecting part 200 and the O-ring 132 in combination with the face 112, which is an outer face, for a fluid that can flow through the inner openings 138 and 238. The connecting parts 100 and 200 are aligned radially with respect to the longitudinal axis L via a tight tolerance, for example a fit H7/h6 or H7/h7 according to DIN ISO 286, of the inner face 246, which is an inner face, with the diameter D246 with respect to the face 112, which is an outer face, with the diameter D112. The axial alignment with respect to the longitudinal axis L of the connecting parts with respect to one another occurs by way of contact of the face 122 of the first connecting part wo and the face 222 of the second connecting part 200.

Thus, easy fitting and clear axial and radial positioning with a low tolerance with a simultaneously sealed connection are possible.

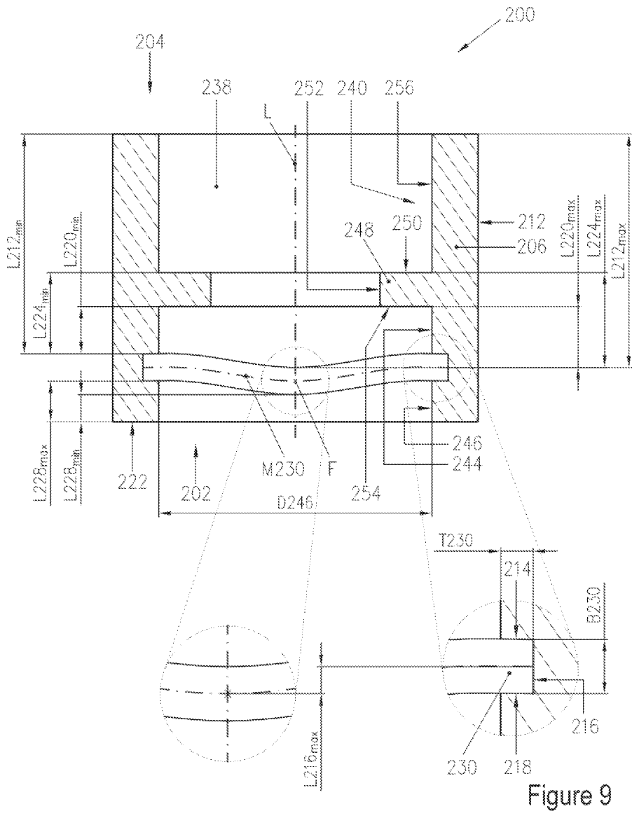

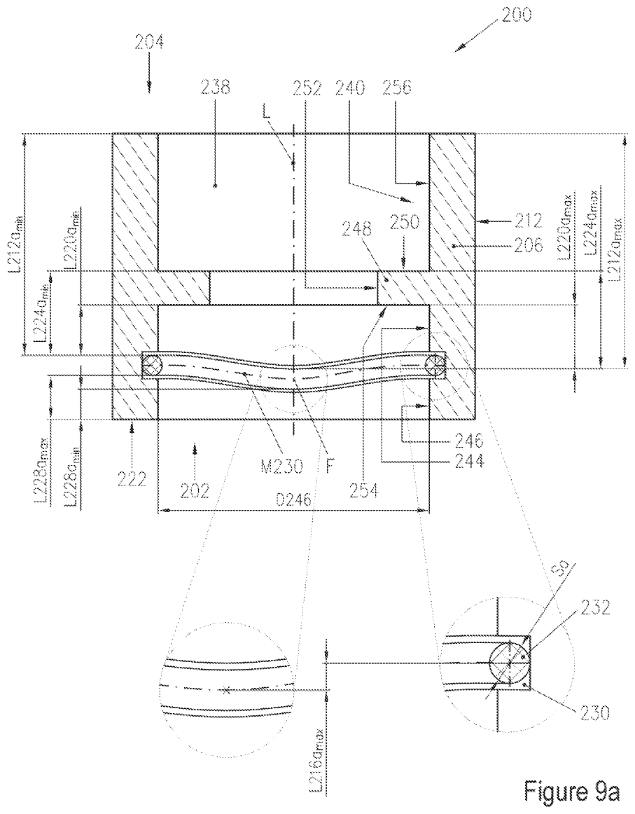

FIG. 9 shows, by way of example, a second connecting part 200, comprising a body 206, which extends along a longitudinal axis L, with a front end 202 and a rear end 204, with an outer face 212 and an inner face 240, which comprises a plurality of faces 214, 216, 218, 244, 246, 250, 252, 254 and 256.

The inner face 240 has an encircling slot 230. The slot 230 is bounded by lateral faces 214 and 218 and the slot bottom 216. The slot 230 has a slot width B230 and a slot depth T230 and is suitable for receiving an O-ring or a profile ring. The slot 230 extends around the circumference. However, a virtual centre line M230 exhibits different distances L216, in the direction of the longitudinal axis L, around the longitudinal axis L, from a fixed point F. The maximum distance L216ₘₐₓ amounts, in this example, to half the slot width B230. In this example, the slot width is 2 mm, and so L216ₘₐₓ amounts to 1 mm.

The second lateral boundary of the slot 230, the face 218, exhibits, parallel to the longitudinal axis L, different distances L228 from the front end 202 of the connecting part 200. The minimum distance is denoted L228ₘᵢₙ and the maximum distance is denoted L228ₘₐₓ. The minimum and maximum distances are each present twice here.

The first lateral boundary of the slot 230, the face 214, exhibits, parallel to the longitudinal axis L, different distances L212 from the rear end 203, different distances L220 from the face 254 of the flange 248 and different distances L224 from the face 250 of the flange 248. The minimum distances, shown in FIGS. 9, of L212, L224 and L220 are denoted L212ₘᵢₙ, L224ₘᵢₙ and L220ₘᵢₙ and the maximum distances are denoted L212ₘₐₓ, L224ₘₐₓ and L220ₘₐₓ The minimum and maximum distances are each present twice here.

It is, of course, possible for more than two minimum and maximum distances to be realized.

The lateral boundaries—the faces 214 and 218—of the slot 230 thus exhibit distances, of different sizes and extending parallel to the longitudinal axis L, from the rear end 204 and from the front end 202.

The difference between the largest and the smallest distance between one and the same boundary of the slot, the lateral face 214, 218 and the rear end 204 or the front end 202 or a face 250 or 254 of the flange 248 corresponds, for example, to half the slot width of for example 2 mm and is 1 mm here.

The face 254 of the flange 248 can serve as an axial stop or for positioning axially with respect to the longitudinal axis L for example in the connecting part wo shown in FIG. 10.

The inner faces 244 and 246 can serve for centring radially with respect to the longitudinal axis L when the connecting part 200 is inserted for example into the connecting part wo shown in FIG. 10.

FIG. 9a shows, by way of example, the connecting part 200 from FIG. 9 with an O-ring 232 in the slot 230.

In this example, the O-ring 232 has a cord size Sa of 1.5 mm. In the middle of the cord, there is a virtual centre line M232. The O-ring 232 extends around the circumference in the slot 130. However, a virtual centre line M232 exhibits different distances L216a, parallel to the longitudinal axis L, around the longitudinal axis L, from a fixed point F. The maximum distance L216aₘₐₓ amounts, in this example, to ⅔ of the cord size Sa. In the example, the cord size Sa is 1.5 mm, and so the maximum distance L216aₘₐₓ amounts to 1 mm.

The outer face, facing in the direction of the rear end 204, of the O-ring 232 exhibits, parallel to the longitudinal axis L, different distances L212a from the rear end 204. The minimum distance is denoted L212aₘᵢₙ and the maximum distance is denoted L212aₘₐₓ.

The outer face, facing in the direction of the front end 202, of the O-ring 232 exhibits, parallel to the longitudinal axis L, different distances L228a from the front end 202. The minimum distance is denoted L228aₘᵢₙ and the maximum distance is denoted L228aₘₐₓ.

The respective outer faces, facing the closer end, of the O-ring 232 thus exhibit, parallel to the longitudinal axis L, axial distances of different sizes from the rear end 204 and from the front end 202.

The minimum and maximum distances are each present twice here.

The difference between the largest and the smallest distance between the outer face, facing the rear end 204, of the O-ring 232 and the rear end 204 and the difference between the largest and the smallest distance between the outer face, facing the front end 202, of the O-ring 232 and the front end 202 corresponds, in this example, to ⅔ of the cord size Sa, in this case 1 mm.

FIG. 10 shows, by way of example, a first connecting part 100, which can be plugged or fitted into the connecting part 200 from FIG. 9a. It comprises a body 106, which extends along a longitudinal axis L, with a front end 102 and a rear end 104, with an outer face no, with a face 112 and an inner face 140. Between the front end 102 and the rear end 104 there extends an opening 138. Located at the rear end 104 is a chamfer 142, which makes it easier to introduce the connecting part boo into the opening 238 in the connecting part 200.

The outer face 112 can serve for centring radially with respect to the longitudinal axis L when the connecting part is inserted for example into the connecting part 200 shown in FIG. 9a.

The connecting part wo has, on the inside, along the longitudinal axis L, a continuous opening 138 with an inner face 140. A fluid can flow through this opening 138 in the installed state.

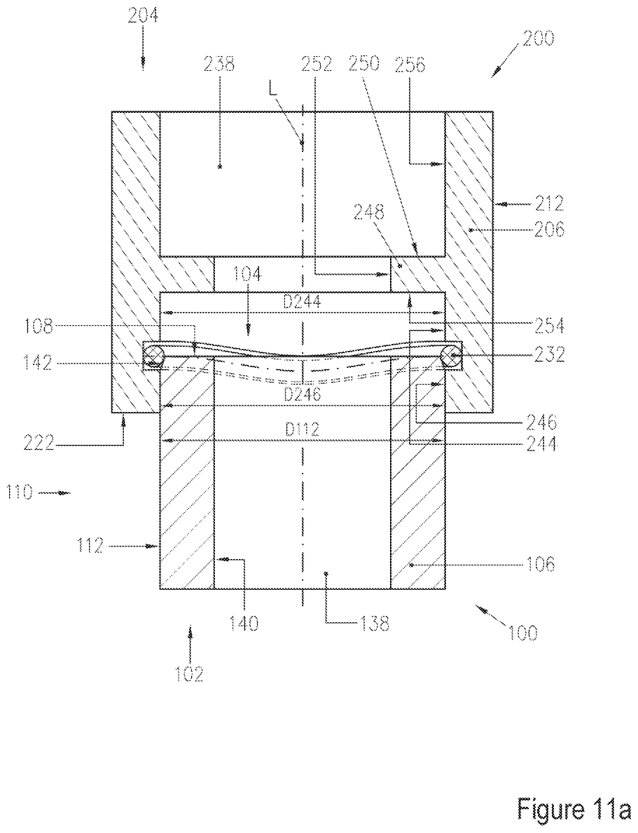

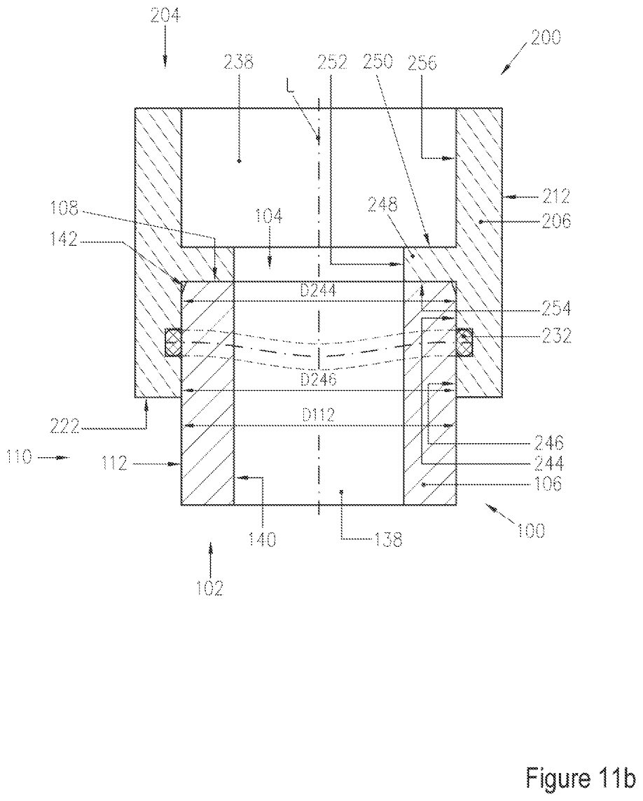

FIGS. 11a and 11b show, by way of example, the connection of the first connecting part boo from FIG. 10 and the second connecting part 200 from FIG. 9a in differently fitted states.

In FIG. 11a, the O-ring 232 is just starting to make contact with the surface of the chamfer 142 at two points (visible on the left and right). Here, an advantage of the invention becomes apparent. It is not necessary for the O-ring 232 to be deformed around its entire circumference right at the start of fitting, rather, in this case, it starts at two points that are arranged on opposite sides around the circumference, and, depending on the fitted state, the deformation takes place gradually around the entire circumference, the points then “travel” around the circumference. As a result, the force required is reduced and plugging together is made easier. An advantage compared with the figures shown in FIGS. 8a and 8b is that, as a result of the O-ring meeting the chamfer 142 at two points, the risk of canting is reduced.

What is advantageous in terms of countering canting is that the start of the deformation is simultaneous at at least three points.

A drawback is that, as the number of contact points at the start of fitting increases, more force is again required for fitting.

FIG. 11b shows, by way of example, the fully fitted or plugged-together connecting parts 100 and 200. The connecting point or line is sealed by the plugging of the first connecting part 100 into the second connecting part 200 and the O-ring 232 in combination with the outer face 112 for a fluid that can flow through the inner openings 138 and 238. The connecting parts 100 and 200 are aligned radially with respect to the longitudinal axis L via a tight tolerance of the inner face 246 with a diameter D246 with respect to the outer face 112 with an outside diameter D112.

The tolerance selected here is for example a fit H7/h6 for D246 and D112 according to DIN ISO 286.

The axial alignment with respect to the longitudinal axis L of the connecting parts with respect to one another occurs by way of contact of the face 108 at the rear end 104 of the first connecting part 100 and the face 254 of the flange 248 of the second connecting part 200.

Thus, easy fitting and clear axial and radial positioning with a low tolerance with a simultaneously sealed connection are possible.

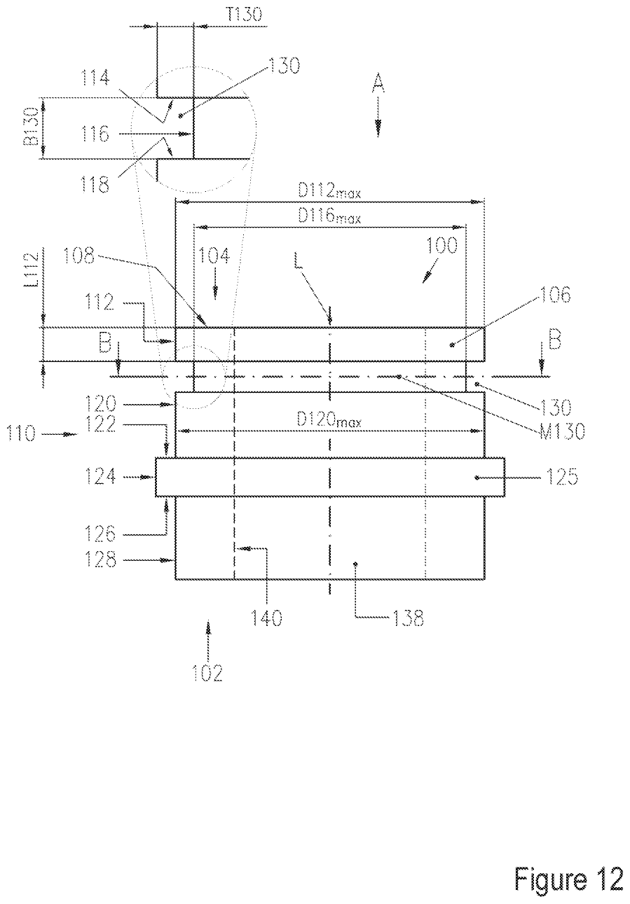

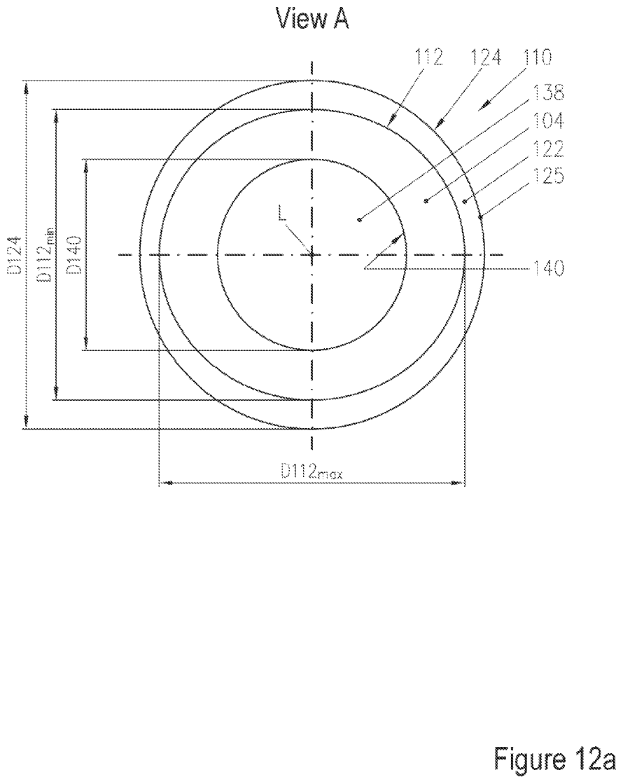

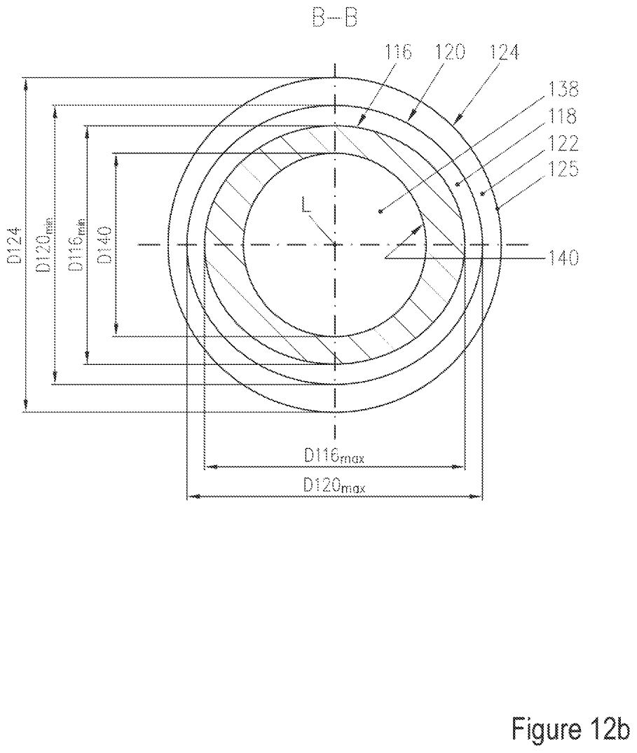

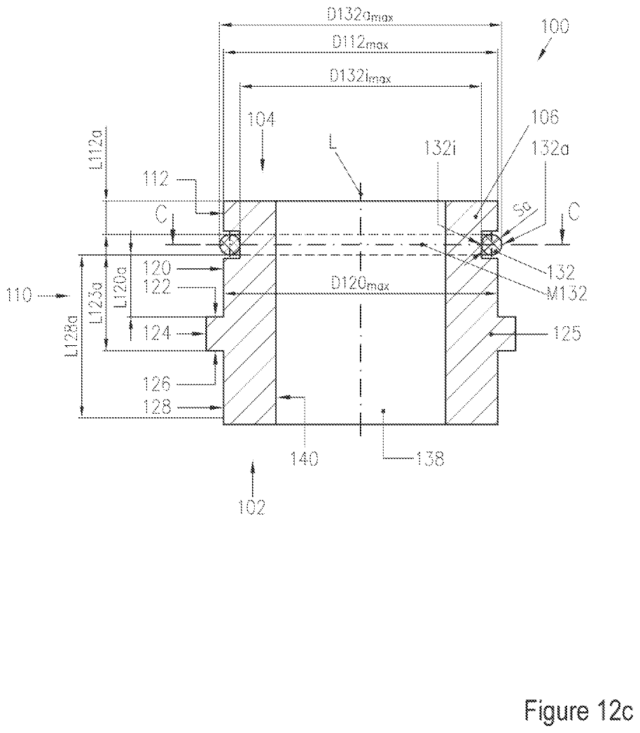

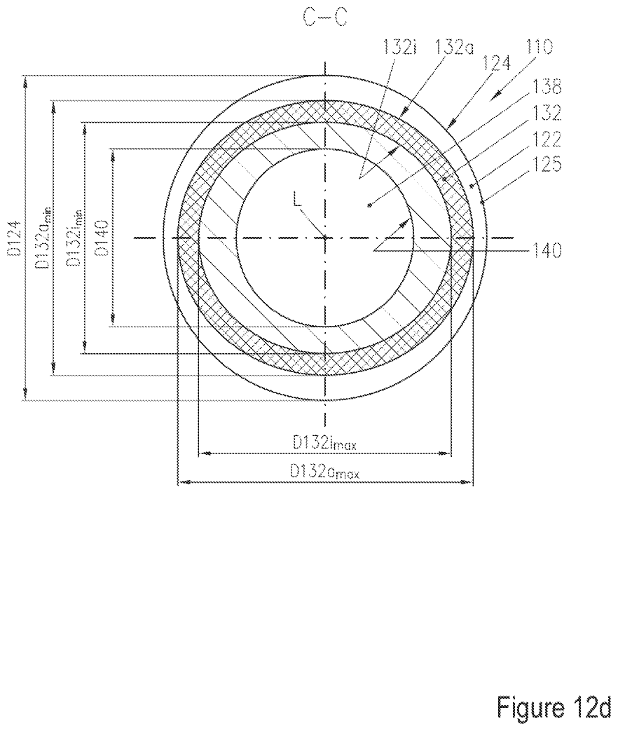

FIG. 12 shows a first connecting part 100, comprising a body 106, which extends along a longitudinal axis L, with a front end 102 and a rear end 104, with an outer face 110, which comprises a plurality of faces 108, 112, 114, 116, 118, 120, 122, 124, 126 and 128.

The outer face 110 has an encircling slot 130. The slot is bounded by lateral faces 114 (facing the rear end 104) and 118 (facing the front end 102) and a slot bottom 116. The slot 130 has a slot width 13130 and a slot depth T130 and is suitable for receiving an O-ring or a profile ring. The slot 130 extends around the circumference. Different slot shapes, as are illustrated by way of example in FIGS. 1a to 1c, may be present.

Furthermore, a flange 125 is located on the outer face 110, said flange being bounded by the faces 122, 124 and 126.

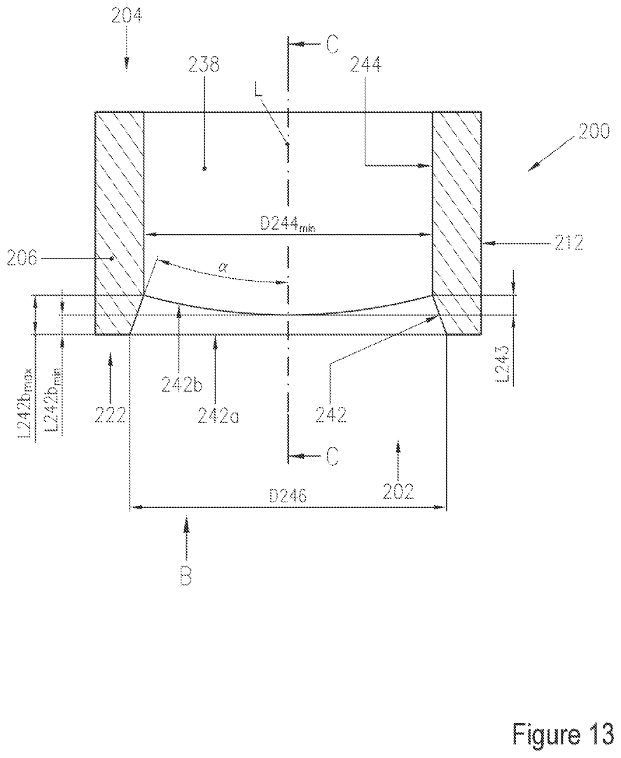

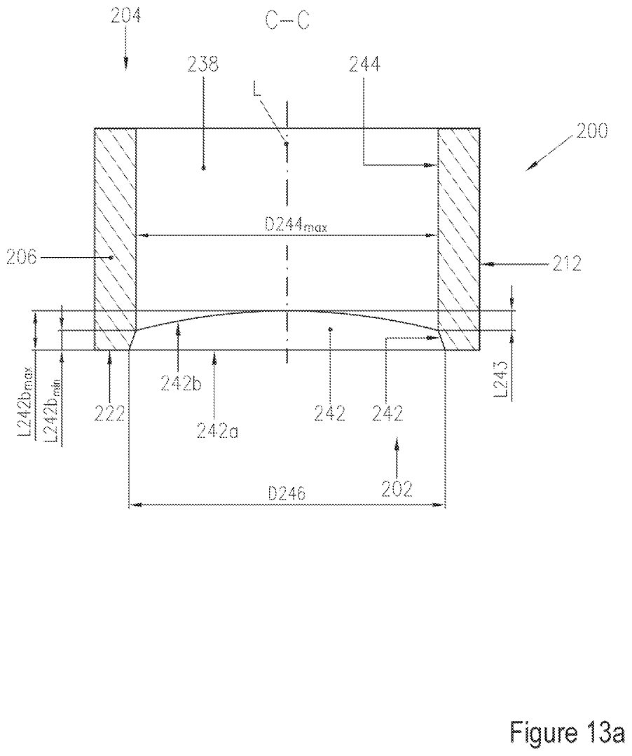

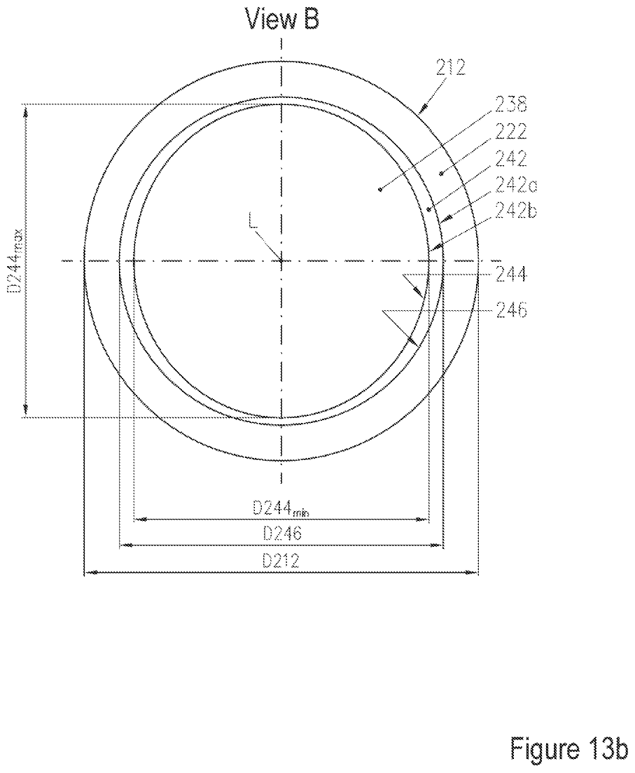

The face 122 of the flange 125 can serve as an axial stop or for positioning axially with respect to the longitudinal axis L for example in the connecting part 200 shown in FIG. 13.

The outer faces 112 and 120 can serve for centring radially with respect to the longitudinal axis L when the connecting part 100 is inserted for example into the connecting part 200 shown in FIG. 13.

The connecting part 100 has, on the inside, along the longitudinal axis L, a continuous opening 138 with an inner face 140. A fluid can flow through this opening 138 in the installed state.

The rear end 104 has an outer face 108.

FIG. 12a shows the view A, i.e. the view as seen from the rear end 104, of the connecting part 100 from FIG. 12. Of the outer face 110, the contours of the face 124 of the flange 125 and of the face 112 are illustrated by way of example. Of the inner face 140, the contour is likewise illustrated by way of example. Furthermore, the face 122 of the flange 125 is shown by way of example. The contour of the flange 125 or of the face 124 is a circle with a diameter D124. The contour of the inner face 140 is likewise a circle with a diameter D140. However, they could also have virtually any other desired shape.

The contour of the face 112 exhibits, in the direction perpendicular to the longitudinal axis L, a smallest distance D112ₘᵢₙ and largest distance D112ₘₐₓ extending through the longitudinal axis. The distances D112 (=radial distances), extending through the longitudinal axis L and perpendicularly to the longitudinal axis L, between the opposite contour portions of the face 112 are therefore not constant around the circumference. The distances vary around the circumference. The largest distance D112ₘₐₓ is also shown in FIG. 12. The contour is, for example, elliptical.

FIG. 12b shows the section B-B through the connecting part from FIG. 12. Of the outer face 110, the contours of the face 124 of the flange 125, of the face 120 and of the face of the slot bottom 116 are illustrated. Of the inner face 140, the contour is likewise illustrated. Furthermore, the face 122 of the flange 125 is shown. The contour of the flange 125 or of the face 124 is a circle with a diameter D124. The contour of the inner face 140 is likewise a circle with a diameter D140. However, they could also have virtually any other desired shape.

The contour of the face 120 exhibits, in the direction perpendicular to the longitudinal axis L, a smallest distance D120ₘᵢₙ and largest distance D120ₘₐₓ extending through the longitudinal axis. The contour of the face of the slot bottom 116 exhibits, in the direction perpendicular to the longitudinal axis L, a smallest distance D116ₘᵢₙ and largest distance D116ₘₐₓ extending through the longitudinal axis.

The distances D120 and D116, extending through the longitudinal axis L and perpendicularly to the longitudinal axis L, between the opposite contour portions of the faces 120 and 116 are therefore not constant around the circumference. The distances vary in this case around the circumference. The maximum distances D116ₘₐₓ and D120ₘₐₓ are also shown in FIG. 12.

In the example shown, the diameter D124=24 mm and the diameter D140=12 mm. The smallest distances D112ₘᵢₙ and D120ₘᵢₙ are 20 mm in this example the largest distances D112ₘₐₓ and D120ₘₐₓ are 21 mm in this example. The difference between the smallest and the largest distance is therefore 1 mm and the largest distance is 5% greater than the smallest distance. The smallest distance D116ₘᵢₙ is 18 mm in this example and the largest distance D116ₘₐₓ is 19 mm in this example, and so the difference between the smallest and the largest distance is 1 mm and the largest distance is about 5.5% greater than the smallest distance.

FIG. 12C shows the connecting part 100 from FIG. 12 with an O-ring 132 in the slot 130.

In this example, the O-ring 132 has a cord size Sa of 1.5 mm. In the middle of the cord, there is a virtual centre line M132. The O-ring 132 extends around the circumference in the slot 130. The slot depth T130 is 1 mm in this example and the slot width B130 is 2 mm.

The inner side, directed towards the longitudinal axis L, of the O-ring 132 is located with its innermost face 132i on the slot bottom 116. The outer side of the O-ring 132 protrudes with its outermost face 132a beyond the outer faces 112 and 120.

FIG. 12d shows the section C-C through the connecting part from FIG. 12 as seen from the rear end 104. The view thus also shows a section through the O-ring 132.

Of the outer face 110, the contours of the face 124 of the flange 125 are illustrated. Of the inner face 140, the contour is likewise illustrated. Furthermore, the face 122 of the flange 125 is shown. The contour of the flange 125 or of the face 124 is a circle with a diameter D124. The contour of the inner face 140 is likewise a circle with a diameter D140. However, they could also have virtually any other desired shape.

The contour of the innermost face 132i of the O-ring 132 exhibits, in the direction perpendicular to the longitudinal axis L, a smallest distance D132iₘᵢₙ and largest distance D132iₘₐₓ extending through the longitudinal axis.

The contour of the outermost face 132a of the O-ring 132 exhibits, in the direction perpendicular to the longitudinal axis L, a smallest distance D132aₘᵢₙ and largest distance D132aₘₐₓ extending through the longitudinal axis.

The distances D132i and D132a, extending through the longitudinal axis L and perpendicularly to the longitudinal axis L, between the opposite contour portions of the faces 132i and 132a of the O-ring 132 are therefore not constant around the circumference. The distances vary in this case around the circumference. The largest distances D132iₘᵢₙ and D132aₘₐₓ are also shown in FIG. 12C.

The smallest distance D132iₘᵢₙ is 18 mm in this example and the largest distance D132iₘₐₓ is 19 mm in this example, and so the difference between the smallest and the largest distance is 1 mm and the largest distance is about 5.5% greater than the smallest distance. Since the cord size Sa of the O-ring is 1.5 mm in this example, the difference of 1 mm is equal to ⅔ of the cord size Sa.

The smallest distance D132aₘᵢₙ is 21 mm in this example and the largest distance D132aₘₐₓ is 22 mm in this example, and so the difference between the smallest and largest distance is 1 mm and the largest distance is about 4.7% greater than the smallest distance. Since the cord size Sa of the O-ring is 1.5 mm in this example, the difference of 1 mm is equal to ⅔ of the cord size Sa.

The contours of the outer faces 112 and 120 may also have a circular shape with a constant diameter D112 and D120 around the circumference, i.e. it is not necessary for there to be a maximum and a minimum distance. However, it is then a condition that the smallest distance D132aₘᵢₙ, extending through the longitudinal axis L and perpendicularly to the longitudinal axis L, between the opposite contour portions of the faces 132a of the O-ring is greater than the two diameters D112 and D120.

FIG. 13 shows a sectional view of an example of a second connecting part 200, into which, for example, the connecting part wo from FIG. 12C can be plugged or fitted. It comprises a body 206, which extends along a longitudinal axis L, with a front end 202 and a rear end 204, with an outer face 212 and inner faces 242 and 244. Between the front end 202 and the rear end 204 there extends an opening 238. Located at the front end 202 is a face 222, which serves as a stop face for the stop face 122 of the connecting part 100 from FIG. 12C.

The opening 238 has, as seen from the front end 202, a second portion with the inner face 242 and a third portion with the inner face 244. At the transition from the outer face 222 to the inner face 242, a body edge 242a is formed. At the transition from the inner face 242 to the inner face 244, a body edge 242b is formed at least around a partial circumference. The body edges 242a and 242b can be for example rounded, for example provided with a radius. At least around a partial circumference, it is formed, in this example, as a chamfer, i.e. obliquely with respect to the longitudinal axis and in this case for example with an angle α, enclosed between the longitudinal axis L and the face 242, of 20° to the longitudinal axis. The body edge 242b exhibits distances L242b of different sizes parallel to the longitudinal axis L from the front end 202. The largest distance is denoted L242bₘₐₓ and the smallest distance is denoted L242bₘᵢₙ. The inner face 242 of the chamfer thus exhibits, around the circumference, different distances between the body edges 242a and 242b both parallel to the longitudinal axis L and parallel to the face 242.

FIG. 13a shows the sectional view C-C of the same connecting part 200, which has been rotated through 90° about the longitudinal axis L compared with the view in FIG. 13. It is intended to further clarify the formation of the face 242, with the description of FIG. 13 otherwise applying.

FIG. 13b shows the view B of the second connecting part 200 from FIG. 13, i.e. as seen from the front end 202. In this case, the outer contour of the outer face 212 and the inner contours of the inner faces 242, 244 and 246, and the body edges 242a and 242b can be seen. The outer contour 212 is, in this example, a circle with a diameter D212, but it could also have some other shape.

Viewing FIGS. 13,13a and 13b together, the design of the opening 238 is described in the following text.

The inner contour of the first portion with the inner face 246, which consists only of the body edge 242a, is a circle with a diameter D246. The inner contour of the third portion with the inner face 244 exhibits, in the direction perpendicular to the longitudinal axis L, a smallest distance D244ₘᵢₙ, which is shown in FIGS. 13 and 13b, and a largest distance D244ₘₐₓ, which is shown in FIGS. 13a and 13b, extending through the longitudinal axis L. The second portion, which forms the transition between the first and the third portion, has, at least around a part of the circumference, a chamfer with the inner face 242, as shown in FIGS. 13 and 13b. The smallest distance D244ₘᵢₙ is smaller than the diameter D246. The largest distance D244ₘₐₓ is in this case equal to the diameter D246, as shown in FIGS. 13a and 13b, but could also be smaller than D246.

In the example shown, the diameter D246=23 mm, the largest distance D244ₘₐₓ=21.2 mm and the smallest distance D244ₘᵢₙ=20.2 mm. The difference between the largest distance D244ₘₐₓ and the smallest distance D244ₘᵢₙ is therefore 1 mm and almost 5%. Therefore, the difference L243 between the maximum distance L242bₘₐₓ and the minimum distance L242bₘᵢₙ is in this case 1.1 mm.

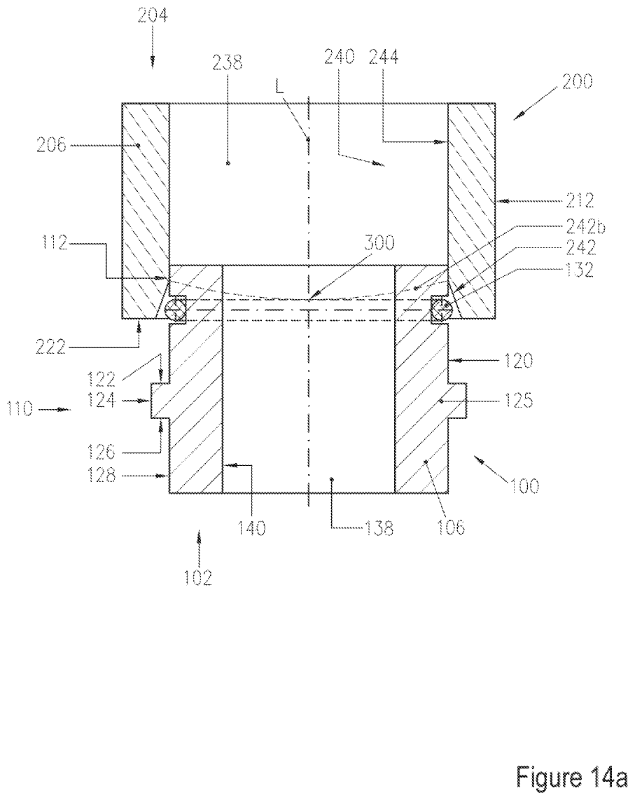

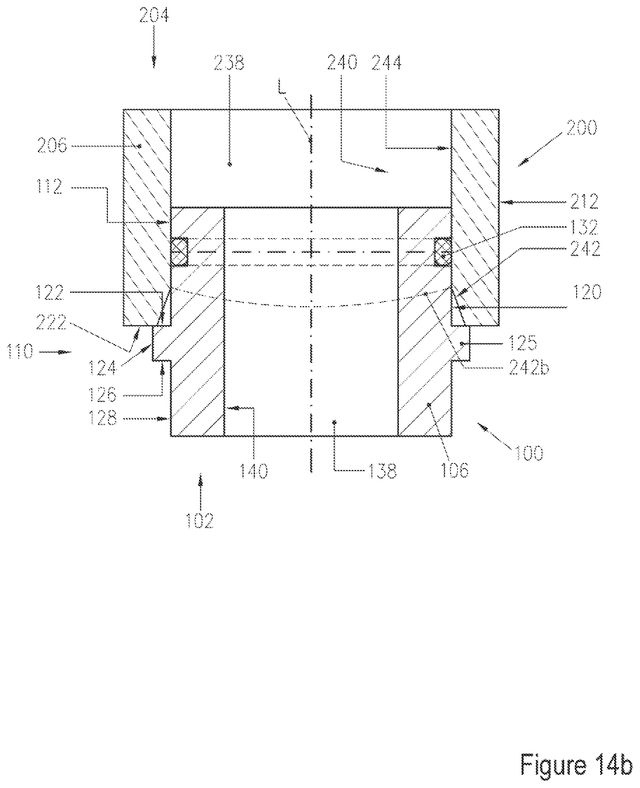

FIGS. 14a and 14b show, by way of example, the connection of the first connecting part 100 from FIG. 12C and the second connecting part 200 from FIG. 13 in differently fitted states.

In FIG. 14a, the O-ring 132 is just starting to make contact with the inner face 242 of the chamfer and with the body edge 242b initially only at two points 300 that are arranged on opposite sides around the circumference, i.e., in this example, only around a partial circumference. Here, an advantage of the invention becomes apparent. It is not necessary for the O-ring 132 to be deformed around its entire circumference right at the start of fitting, rather it starts initially at two points, i.e. around a partial circumference, and, depending on the fitted state, the deformation takes place gradually around the entire circumference. As a result, the force required is reduced and plugging together is made easier.

FIG. 14b shows the fully fitted or plugged-together connecting parts 100 and 200. The connecting point or line is sealed by the plugging of the first connecting part 100 into the second connecting part 200 and the O-ring 132 in combination with the inner face 240 for a fluid that can flow through the inner openings 138 and 238. The connecting parts 100 and 200 are aligned radially with respect to the longitudinal axis L via a tight tolerance, for example a fit H7/h6 or H7/h7 according to DIN ISO 286, of the inner face 244 with respect to the outer face 112. The axial alignment with respect to the longitudinal axis L of the connecting parts 100 and 200 with respect to one another occurs by way of contact of the face 122 of the first connecting part wo and the face 222 of the second connecting part 200.

Thus, easy fitting and clear axial and radial positioning with respect to the longitudinal axis L with a low tolerance with a simultaneously sealed connection of the connecting parts 100 and 200 are possible.

FIG. 15 shows a first connecting part 100, comprising a body 106, which extends along a longitudinal axis L, with a front end 102 and a rear end 104, with an outer face 110, which comprises a plurality of faces 112, 114, 116, 118, 120, 122, 124, 126, 128, 134 and 136.

The outer face no has an encircling slot 130. The slot is bounded by lateral faces 114 and 118 and a slot bottom 116. The slot 130 has a slot width B130 and a slot depth, which is suitable for receiving an O-ring or a profile ring. The slot 130 extends around the circumference. Different slot shapes, as are illustrated by way of example in FIGS. 1a to 1c, may be present.

Furthermore, a flange 125 is located on the outer face 110, said flange being bounded by the faces 122, 124 and 126.

Furthermore, an outer face 134 is located on the outer face 110. The portion with the outer face 124 has a diameter D134 that is greater than the diameter D120 of the portion with the outer face 120.

The outer face 134 serves for centring radially with respect to the longitudinal axis L when the connecting part is inserted for example into the connecting part 200 shown in FIG. 16a.

The face 122 of the flange 125 can serve as an axial stop or for positioning axially with respect to the longitudinal axis L for example in the connecting part 200 shown in FIG. 16a.

The connecting part 100 has, on the inside, along the longitudinal axis L, a continuous opening 138 with an inner face 140. A fluid can flow through this opening 138 in the installed state.

The rear end 104 has an outer face 108.

FIG. 15a shows the view A, i.e. the view as seen from the rear end 104, of the connecting part 100 from FIG. 15. Of the outer face 110, the contours of the face 124 of the flange 125, of the face 112 and of the face 134, which acts as a centring face, are illustrated. Of the inner face 140, the contour is likewise illustrated. Furthermore, the face 122 of the flange 125 and the face 136 are shown. Furthermore, the face 108 of the rear end 104 is shown.

The contour of the face 124 is a circle with a diameter D124. The contour of the face 134 is a circle with a diameter D134. The contour of the inner face 140 is likewise a circle with a diameter D140. However, the contours may also have virtually any other desired shape.

The contour of the face 112 exhibits, in the direction perpendicular to the longitudinal axis L, a smallest distance D112ₘᵢₙ and largest distance D112ₘₐₓ extending through the longitudinal axis. The distances D112, extending through the longitudinal axis L and perpendicularly to the longitudinal axis L, between the opposite contour portions of the face 112 are therefore not constant around the circumference. The distances vary around the circumference. The largest distance D112ₘₐₓ is also shown in FIG. 15.

FIG. 15b shows the section B-B through the connecting part from FIG. 15. Of the outer face 110, the contours of the face 124 of the flange 125, of the face 120, of the face 134 and of the face of the slot bottom 116 are illustrated. Of the inner face 140, the contour is likewise illustrated. Furthermore, the face 122 of the flange 125 is shown. The face 136 is likewise shown. The contour of the face 124 is a circle with a diameter D124, the contour of the face 134 is a circle with a diameter D134 and the contour of the face 120 is likewise a circle with a diameter D120. The contour of the inner face 140 is likewise a circle with a diameter D140. However, they could also have virtually any other desired shape. What is important is that the largest distance, extending perpendicularly to the longitudinal axis, between the longitudinal axis L and one or more points or portions of the contour of the face 134 is larger than the largest distance, extending perpendicularly to the longitudinal axis, between the longitudinal axis L and one or more points or portions of the contour of the face 120.

The contour of the face of the slot bottom 116 exhibits, in the direction perpendicular to the longitudinal axis L, a smallest distance D116ₘᵢₙ and largest distance D116ₘₐₓ extending through the longitudinal axis.

The distances D116, extending through the longitudinal axis L and perpendicularly to the longitudinal axis L, between the opposite contour portions of the faces 116 are therefore not constant around the circumference. The distances vary in this case around the circumference. The maximum distance D116ₘₐₓ is also shown in FIG. 15.

In the example shown, the diameter D124=24 mm, the diameter D140=12 mm, the diameter D120=20 mm and the diameter D134=23 mm. The diameter D134 has a particularly tight tolerance, for example with a fit h6 (−13 to 0 μm) or h7 (−21 to 0 μm) according to DIN ISO 286. The smallest distance D116ₘᵢₙ is 18 mm in this example and the largest distance D116ₘₐₓ is 19 m here, and so the difference between the smallest and the largest distance is 1 mm and the largest distance is about 5.5% greater than the smallest distance.

The smallest distance D112ₘᵢₙ is 20 mm in this example and the largest distance D112ₘₐₓ is 21 mm in this example, and so the difference between the smallest and the largest distance is 1 mm and the largest distance is 5% greater than the smallest distance.

The slot depth T112, i.e. the distance between the slot bottom 116 and the face 112 perpendicularly to the longitudinal axis L or along the lateral boundary face 114 of the slot 130, is constantly 1 mm in this example [T112=(D112ₘᵢₙ−D116ₘᵢₙ)/2 and T112=(D112ₘₐₓ−D116ₘₐₓ)/2]. The smallest distance between the slot bottom 116 and the face 120 perpendicularly to the longitudinal axis L or along the lateral boundary face 114 of the slot 130 is 0.5 mm in this example [T120ₘᵢₙ=(D120−D116ₘᵢₙ)/2] and the largest distance T120ₘₐₓ is 1 mm in this example [T120ₘₐₓ=(D120−D116ₘᵢₙ)/2].

On one side of the slot, in this example on the side of the face 118, the slot exhibits different distances, extending axially with respect to the longitudinal axis L, between the slot bottom 116 and the face 120 around the circumference.

The diameter D120 has to be greater than the smallest distance D116ₘᵢₙ and smaller than the largest distance D112ₘₐₓ or equal thereto [D116ₘᵢₙ<D120<=D112ₘₐₓ].

FIG. 15e shows the connecting part wo from FIG. 15 with an O-ring 132 in the slot 130.

The O-ring 132 has a cord size Sa of, for example, 1.5 mm. In the middle of the cord, there is a virtual centre line M132. The O-ring 132 extends around the circumference in the slot 130.

The inner side, directed towards the longitudinal axis L, of the O-ring 132 is located with its innermost face 132i on the slot bottom 116. The outer side of the O-ring 132 protrudes with its outermost face 132a beyond the outer faces 112 and 120.

FIG. 15d shows the section C-C through the connecting part from FIG. 15c as seen from the rear end 104. The view thus also shows a section through the O-ring 132.

Of the outer face 110, the contours of the face 124 of the flange 125 and of the face 134 are illustrated. Of the inner face 140, the contour is likewise illustrated. Furthermore, the face 122 of the flange 125 and the face 136 are shown. The contour of the face 124 is a circle with a diameter D124, and the contour of the face 134 is a circle with a diameter D134. The contour of the inner face 140 is likewise a circle with a diameter D140. However, they may also have virtually any other desired shape.

The contour of the innermost face 132i of the O-ring 132 exhibits, in the direction perpendicular to the longitudinal axis L, a smallest distance D132iₘᵢₙ and largest distance D132iₘₐₓ extending through the longitudinal axis L.

The contour of the outermost face 132a of the O-ring 132 exhibits, in the direction perpendicular to the longitudinal axis L, a smallest distance D132aₘᵢₙ and largest distance D132aₘₐₓ extending through the longitudinal axis L.

The smallest distance D132ₘᵢₙ of the innermost face 132i is 18 mm in this example and the largest distance D132iₘₐₓ of the innermost face 132i is 19 mm in this example, and so the difference between the smallest and the largest distance is 1 mm and the largest distance is about 5.5% greater than the smallest distance. Since the cord size Sa of the O-ring is 1.5 mm in this example, the difference of 1 mm is ⅔ of the cord size Sa.

The smallest distance D132aₘᵢₙ of the outermost face 132a is 21 mm in this example and the largest distance D132aₘₐₓ of the outermost face 132a is 22 mm in this example, and so the difference between the smallest and largest distance is 1 mm and the largest distance is about 4.7% greater than the smallest distance. Since the cord size Sa of the O-ring is 1.5 mm in this example, the difference of 1 mm is ⅔ of the cord size Sa.

The smallest distance D132aₘᵢₙ, extending through the longitudinal axis and perpendicularly to the longitudinal axis L, between the opposite contour portions of the faces 132a of the O-ring has to be greater than the diameter D120.

The largest distance D132aₘₐₓ extending through the longitudinal axis and perpendicularly to the longitudinal axis L, between the opposite contour portions of the faces 132a of the O-ring has to be greater than the largest distance D112ₘₐₓ.

FIG. 16 shows, by way of example, a sectional view of a second connecting part 200, into which, for example, the connecting part wo from FIG. 15c can be plugged or fitted. It comprises a body 206, which extends along a longitudinal axis L, with a front end 202 and a rear end 204, with an outer face 212 and inner faces 242, 244 and 246. Between the front end 202 and the rear end 204 there extends an opening 238. Located at the front end 202 is a face 222, which serves as a stop face for the stop face 122 of the connecting part 100 from FIG. 15.

The opening 238 has, as seen from the front end 202, a first portion with the inner face 246, a second portion with the inner face 242 and a third portion with the inner face 244. At the transition from the inner face 246 to the inner face 242, a body edge 242a is formed. At the transition from the inner face 242 to the inner face 244, a body edge 242b is formed around the entire circumference in this example. The body edges 242a and 242b can be rounded, for example provided with a radius. The inner face 242 is thus located between the inner faces 246 and 244. By way of example, a chamfer, i.e. oblique with respect to the longitudinal axis L and in this case for example with an angle α, enclosed between the longitudinal axis L and the face 242, of 20° to the longitudinal axis is formed around the entire circumference and realizes the transition between the first portion with the inner face 246 and the third portion with the inner face 244. The body edge 242b exhibits distances L242b of different sizes parallel to the longitudinal axis L from the front end 202. The largest distance is denoted L242bₘₐₓ and the smallest distance is denoted L242bₘᵢₙ. The inner face 242 of the chamfer thus exhibits, around the circumference, different distances between the body edges 242a and 242b both parallel to the longitudinal axis L and parallel to the face 242. The distances of the body edges 242b from the front end 202 parallel to the longitudinal axis are greater than the distance of the body edge 242a from the front end 202.

FIG. 16a shows the sectional view C-C of the same connecting part 200, which has been rotated through 90° about the longitudinal axis L compared with the view in FIG. 16. It is intended to further clarify the formation of the face 242, with the description of FIG. 16 otherwise applying.

FIG. 16b shows the view B of the second connecting part 200 from FIG. 16, i.e. as seen from the front end 202. In this case, the outer contour of the outer face 212 and the inner contours of the inner faces 242, 244 and 246, and the body edges 242a and 242b can be seen. The outer contour 212 is a circle with a diameter D212, but could also have some other shape. It is apparent that the inner face 242 of the chamfer extends around the entire circumference in this exemplary embodiment.

Viewing FIGS. 16, 16a and 16b together, the design of the opening 238 is described in the following text.

The inner contour of the first portion with the inner face 246 is a circle with a diameter D246. The inner contour of the third portion with the inner face 244 exhibits, in the direction perpendicular to the longitudinal axis L, a smallest distance D244ₘᵢₙ, which is shown in FIGS. 16a and 16131, and a largest distance D244ₘₐₓ, which is shown in FIGS. 16 and 16b, extending through the longitudinal axis. The second portion, which forms the transition between the first and the third portion, has in this case, around the entire circumference, a chamfer with the inner face 242, as shown in FIGS. 16, 16a and 16b. The largest distance D244ₘₐₓ is in this case smaller than the diameter D246, as shown in FIGS. 16 and 16b.

In the example shown, the diameter D246=23 mm, the largest distance D244ₘₐₓ=21.2 mm and the smallest distance D244ₘᵢₙ=20.2 mm. The difference between the largest distance D244ₘₐₓ and the smallest distance D244ₘᵢₙ is therefore 1 mm and thus almost 5% of the largest distance. Therefore, the difference between the maximum distance L242bₘₐₓ and the minimum distance L242bₘᵢₙ is 1.1 mm in this example.

The diameter D246 has a particularly tight tolerance, for example with a fit H7 (0 to +21 μM) according to DIN ISO 286. As a result, a radial alignment or centring with respect to the longitudinal axis L is realized between the first connecting part 100 and the second connecting part 200. The outer face 134 of the first connecting part 100 and the inner face 246 of the second connecting part 200 are arranged at a distance with a tight tolerance from one another and are at least partially in contact.

FIGS. 17a and 17b show, by way of example, the connection of the first connecting part 100 from FIGS. 15 and 15c and the second connecting part 200 from FIG. 16 in differently fitted states.

In FIG. 17a, the O-ring 132 is just starting to make contact with the inner face 242 of the chamfer 242 and with the body edge 242b initially only at two points 300. Here, an advantage of the invention becomes apparent. It is not necessary for the O-ring 132 to be deformed around its entire circumference right at the start of fitting, rather it starts initially at two points, i.e. around a partial circumference, and, depending on the fitted state, the deformation takes place gradually around the entire circumference. As a result, the force required is reduced and plugging together is made easier.

FIG. 17b shows the fully fitted or plugged-together connecting parts 100 and 200. The connecting point or line is sealed by the plugging of the first connecting part 100 into the second connecting part 200 and the O-ring 132 in combination with the inner face 240 for a fluid that can flow through the inner openings 138 and 238. The connecting parts 100 and 200 are aligned radially with respect to the longitudinal axis L via a tight tolerance, for example a fit h6/H7 according to DIN ISO 286, of the inner face 246 with the diameter D246 (H7, from 0 to +21 μM) with respect to the outer face 134 with the diameter D134 (h6, from −13 to 0 μm). A fit h7/H7 according to DIN ISO 286 of the inner face 246 with the diameter D246 (H7, from 0 to +21 μM) with respect to the outer face 134 with the diameter D134 (h7, from −21 to 0 μM) is also possible, for example. The axial alignment with respect to the longitudinal axis L of the connecting parts 100 and 200 with respect to one another occurs by way of the contact of the face 122 of the first connecting part 100 and the face 222 of the second connecting part 200.

Thus, easy fitting and clear axial and radial positioning with a low tolerance with a simultaneously sealed connection are possible.

In addition, as a result of the design of the outer counter of the face 112 (outer face) of the connecting part 100 with the largest distance D112ₘₐₓ and the minimum distance D112ₘᵢₙ and the design of the contour of the face (inner face) 244 with the maximum distance D244ₘₐₓ and the minimum distance D244ₘᵢₙ, positioning around the circumference is also possible. In the example shown, there are exactly two positions, offset rotationally through 180° about the longitudinal axis L, in which the connecting parts can be fitted or plugged into one another, specifically at the points where the faces 112 and 244 are arranged with their D112ₘₐₓ and D244ₘₐₓ, and D112ₘᵢₙ and D244ₘᵢₙ opposite one another.

FIG. 18 shows a first connecting part mo, comprising a body 106, which extends along a longitudinal axis L, with a front end 102 and a rear end 104, with an outer face 110, which comprises a plurality of faces 112, 114, 116, 118, 120, 122, 124, 126, 128, 134, 136, 144 and 146.

The outer face 110 has an encircling slot 130. The slot is bounded by lateral faces 114 and 118 and a slot bottom 116. The slot 130 has a slot width B130 and a slot depth, which is suitable for receiving an O-ring or a profile ring. The slot 130 extends around the circumference. Different slot shapes, as are illustrated by way of example in FIGS. 1a to 1c, may be present.

Furthermore, a flange 125 is located on the outer face 110, said flange being bounded by the faces 122, 124 and 126.

A face 144 is located on the outer face 110, said face being located between the face 120 and the outer face 134. The portion with the face 144 has a diameter D144, which is greater than the largest distance D120ₘₐₓ, extending in the direction perpendicular to the longitudinal axis L and through the longitudinal axis L, of the face 120.

Three slots or recesses 144a, 144b and 144c are located in the outer face 144, wherein only 2 slots are visible in this view. The slots extend parallel to the longitudinal axis L. These secure, for example in conjunction with the noses of the connecting part 200 from FIG. 19, the position, rotationally with respect to the longitudinal axis L around the circumference, of the connecting parts with respect to one another.

Furthermore, a face 134 is located on the outer face 110, said face acting as a centring face, and a face 136. The portion with the face 134 has a diameter D134, which is greater than the largest distance D120ₘₐₓ of the face 120 and greater than the diameter D144 of the portion of the face 144.

The face 134 serves for centring radially with respect to the longitudinal axis L when the connecting part 100 is inserted for example into the connecting part 200 shown in FIG. 19a.

The stop face 122 serves as an axial stop or for positioning axially with respect to the longitudinal axis L for example in the connecting part 200 shown in FIG. 19a.

The connecting part 100 has, on the inside, along the longitudinal axis L, a continuous opening 138 with an inner face 140. A fluid can flow through this opening 138 in the installed state.

FIG. 18a shows the view A, i.e. the view as seen from the rear end 104, of the connecting part from FIG. 18. Of the outer face 110, the contours of the face 124 of the flange 125, of the face 120, of the face 112, of the face 144 and of the face 134, which acts as a centring face, are illustrated. Of the inner face 140, the contour is likewise illustrated. Furthermore, the face 122 of the flange 125, the face 146 and the face 136 are shown. The contour of the face 124 is a circle with a diameter D124. The contour of the face 112 is likewise a circle with a diameter D112. The contour of the outer face 144 is likewise a circle and has in this case, for example, three slots 144a, 144b and 144c. The contour of the face 134 is a circle with a diameter D134. The contour of the inner face 140 is likewise a circle with a diameter D140. However, the contours may also have virtually any other desired shape.

The contour of the face 120 exhibits, in the direction perpendicular to the longitudinal axis L, a smallest distance D120ₘᵢₙ and largest distance D120ₘₐₓ extending through the longitudinal axis.

FIG. 18b shows the section B-B through the connecting part from FIG. 18. Of the outer face 110, the contours of the face 124 of the flange 125, of the face 120, of the face 144, of the face 134 and of the face of the slot bottom 116 are illustrated. Of the inner face 140, the contour is likewise illustrated. Furthermore, the face 122 of the flange 125 is shown. The faces 136 and 146 are likewise shown. The contour of the face 124 is a circle with a diameter D124, the contour of the face 134 is a circle with a diameter D134. The contour of the outer face 144 is likewise a circle and has in this case, for example, three slots 144a, 144b and 144c. The contour of the inner face 140 is likewise a circle with a diameter D140. However, they may also have virtually any other desired shape.

What is important is that the largest distance, extending perpendicularly to the longitudinal axis, between the longitudinal axis L and one or more points or portions of the contour of the face 134 is larger than the largest distance, extending perpendicularly to the longitudinal axis, between the longitudinal axis L and one or more points or portions of the contour of the faces 112, 120 and 144.

The contour of the face 120 exhibits, in the direction perpendicular to the longitudinal axis L, a smallest distance D120ₘᵢₙ and largest distance D120ₘₐₓ extending through the longitudinal axis. In this example the smallest distance D120ₘᵢₙ is 20 mm and the largest distance D120ₘₐₓ=21 mm. The contour of the face of the slot bottom 116 exhibits, in the direction perpendicular to the longitudinal axis L, a smallest distance D116ₘᵢₙ and largest distance D116ₘₐₓ extending through the longitudinal axis.

In the example shown, the diameter D112=20 mm, the diameter D124=24 mm, the diameter D140=12 mm, the diameter D144=23 mm and the diameter D 134=23.5 mm.

Therefore, D134>D144>D120ₘₐₓ>D112.

The diameter D134 has a particularly tight tolerance, for example with a fit h6 (−13 to 0 μm) or h7 (−21 to 0 μm) according to DIN ISO 286. The smallest distance D116ₘᵢₙ is 18 mm in this example and the largest distance D116ₘₐₓ is 19 mm in this example, and so the difference between the smallest and the largest distance is 1 mm and the largest distance is about 5.5% greater than the smallest distance.

The slot depth T120, i.e. the distance between the slot bottom 116 and the face 120 perpendicularly to the longitudinal axis L or along the lateral boundary face 118 of the slot 130, is constantly 1 mm in this example [T120=(D120ₘᵢₙ−D116ₘᵢₙ)/2 and T120=(D120ₘₐₓ−D116ₘₐₓ)/2].

The minimum distance between the slot bottom 116 and the face 112 perpendicularly to the longitudinal axis L or along the lateral boundary face 114 of the slot 130 is 0.5 mm in this example [T112ₘᵢₙ=(D112−D116ₘₐₓ)/2] and the largest distance T112ₘₐₓ is 1 mm [T112ₘₐₓ=(D112−D116ₘᵢₙ)/2].

On one side of the slot, in this case on the side of the face 114, the slot 130 exhibits different distances T112, extending axially with respect to the longitudinal axis L, between the slot bottom 116 and the face 112 around the circumference.

The largest distance D120ₘₐₓ has to be greater than the largest distance D116ₘₐₓ and than the diameter D112 and the latter has to be greater than the largest distance D116ₘₐₓ [D120ₘₐₓ>D112>D116ₘₐₓ].

FIG. 18c shows, by way of example, the connecting part 100 from FIG. 18 with an O-ring 132 in the slot 130.

In this example, the O-ring 132 has a cord size Sa of 1.5 mm. In the middle of the cord, there is a virtual centre line M132. The O-ring 132 extends around the circumference in the slot 130. The inner side, directed towards the longitudinal axis L, of the O-ring is located with its innermost face 132i on the slot bottom 116. The outer side of the O-ring 132 protrudes with its outermost face 132a beyond the outer faces 112 and 120. The outer side of the O-ring 132 does not protrude with its outermost face 132a beyond the outer faces 144 and 134. It is advantageous when it also does not protrude beyond the bottoms of the slots 144a, 144b and 144c.

FIG. 18c1 shows the section C-C through the connecting part from FIG. 18c as seen from the rear end 104. The view thus also shows a section through the O-ring 132.

Of the outer face 110, the contours of the face 124 of the flange 125, of the face 134 and of the face 144 are illustrated. Of the inner face 140, the contour is likewise illustrated. Furthermore, the face 122 of the flange 125 and the face 136 are shown. The contour of the face 124 is a circle with a diameter D124, and the contour of the face 134 is a circle with a diameter D134. The contour of the outer face 144 is likewise a circle and has in this case, for example, three slots 144a, 144b and 144c. The contour of the inner face 140 is likewise a circle with a diameter D140. However, they may also have virtually any other desired shape.

The contour of the innermost face 132i of the O-ring 132 exhibits, in the direction perpendicular to the longitudinal axis L, a smallest distance D132iₘᵢₙ and largest distance D132iₘₐₓ extending through the longitudinal axis.

The contour of the outermost face 132a of the O-ring 132 exhibits, in the direction perpendicular to the longitudinal axis L, a smallest distance D132aₘᵢₙ and largest distance D132aₘₐₓ extending through the longitudinal axis.

The smallest distance D132iₘᵢₙ is 18 mm in this example and the largest distance D132iₘₐₓ is 19 mm in this example, and so the difference between the smallest and the largest distance is 1 mm and the largest distance is about 5.5% greater than the smallest distance. Since the cord size Sa of the O-ring is 1.5 mm, the difference of 1 mm is ⅔ of the cord size Sa.

The smallest distance D132aₘᵢₙ is 21 mm in this example and the largest distance D132aₘₐₓ is 22 mm in this example, and so the difference between the smallest and largest distance is 1 mm and the largest distance is about 4.7% greater than the smallest distance. Since the cord size Sa of the O-ring is 1.5 mm in this example, the difference of 1 mm is ⅔ of the cord size Sa.

As described in FIG. 18, the smallest distance D120ₘᵢₙ is 20 mm and is this smaller than the smallest distance D132aₘᵢₙ of 21 mmmm and the largest distance D120ₘₐₓ=21 is smaller than the largest distance D132aₘₐₓ of 22 mm.

FIG. 19 shows a sectional view of a second connecting pall 200, into which, for example, the connecting part wo from FIG. 18c can be plugged or fitted. It comprises a body 206, which extends along a longitudinal axis L, with a front end 202 and a rear end 204, with an outer face 212 and the inner faces 242, 244, 246 and 258. Between the front end 202 and the rear end 204 there extends an opening 238. Located at the front end 202 is a face 222, which serves as a stop face for the stop face 122 of the connecting part wo from FIG. 18.

The opening 238 has, as seen from the front end 202, a first portion with the inner face 246, a fourth portion with the inner face 258, a second portion with the inner face 242 and a third portion with the inner face 244. At the transition from the inner face 258 to the inner face 242, a body edge 242a is formed. At the transition from the inner face 242 to the inner face 244, a body edge 242b is formed around the entire circumference in this example. The body edges 242a and 242b can be, for example, rounded, for example provided with a radius. The inner face 242 is thus located between the inner faces 258 and 244. By way of example, a chamfer, i.e. oblique with respect to the longitudinal axis L and in this case for example with an angle α, enclosed between the longitudinal axis L and the face 242, of 20° to the longitudinal axis is formed around the entire circumference and realizes the transition between the fourth portion with the inner face 258 and the third portion with the inner face 244. The body edge 242b exhibits distances L242b of different sizes parallel to the longitudinal axis L from the front end 202; the largest distance is denoted L242bₘₐₓ and the smallest distance is denoted L242bₘᵢₙ. The inner face 242 of the chamfer thus exhibits, around the circumference, different distances between the body edges 242a and 242b both parallel to the longitudinal axis L and parallel to the face 242. The distances of the body edges 242b from the front end 202 parallel to the longitudinal axis L are greater than the distance of the body edge 242a from the front end 202.

Located on the inner face of the second portion are, for example, three noses or protrusions 258a, 258b and 259c. In this figure, only the protrusion 258b can be seen.

FIG. 19a shows the sectional view C-C of the same connecting part 200, which has been rotated through 90° about the longitudinal axis L compared with the view in FIG. 19. It is intended to further clarify the formation of the face 242, with the description of FIG. 19 otherwise applying. The protrusions 258a and 258c can likewise be seen here on the inner face 258.

FIG. 19b shows the view B of the second connecting part 200 from FIG. 19a, i.e. as seen from the front end 202. In this case, the outer contour of the outer face 212 and the inner contours of the inner faces 242, 244, 246 and 258 with the protrusions 258a, 258b and 258c, and the body edges 242a and 242b can be seen. The outer contour 212 is a circle with a diameter D212, but could also have some other shape. It is apparent that the inner face 242 of the chamfer extends around the entire circumference in this exemplary embodiment.

Viewing FIGS. 19,19a and 19b together, the design of the opening 238 is described in the following text.

The inner contour of the first portion with the inner face 246 is a circle with a diameter D246. The inner contour of the fourth portion with the inner face 258 is a circle with a diameter D258 having the protrusions or noses 258a, 258b and 258c, which are distributed around the circumference of the inner face and designed such that, when plugging together and in the plugged-together state with the connecting part 100, they are engaged with the slots or recesses 144a, 144b and 144c. The inner contour of the third portion with the inner face 244 exhibits, in the direction perpendicular to the longitudinal axis L, a smallest distance D244ₘᵢₙ, which is shown in FIGS. 19 and 19b, and a largest distance D244ₘₐₓ which is shown in FIGS. 19a and 19b, extending through the longitudinal axis. The second portion, which forms the transition between the fourth and the third portion, has in this case, around the entire circumference, a chamfer with the inner face 242, as shown in FIGS. 19, 19a and 19b. The largest distance D244ₘₐₓ is in this case smaller than the diameter D246, as shown in FIGS. 19a and 19b.

In the example shown, the diameter D246=23 mm, the largest distance D244ₘₐₓ=21.2 mm and the smallest distance D244ₘᵢₙ=20.2 mm. The difference between the largest distance D244ₘₐₓ and the smallest distance D244ₘᵢₙ is therefore 1 mm and thus almost 5% of the largest distance. Therefore, the difference L243 between the maximum distance L242bₘₐₓ and the minimum distance L242bₘᵢₙ is in this case 1.1 mm.

The diameter D246 has a particularly tight tolerance, for example with a fit H7 (o to +21 vtm) according to DIN ISO 286. As a result, the radial alignment or centring with respect to the longitudinal axis L is realized between the first connecting part 100 and the second connecting part 200. The outer face 134 of the first connecting part 100 and the inner face 246 of the second connecting part 200 are arranged at a distance with a tight tolerance from one another and are at least partially in contact.

FIGS. 20a and 20b show, by way of example, the connection of the first connecting part 100 from FIG. 18c and the second connecting part 200 from FIG. 19 in differently fitted states. The connecting parts have been plugged into one another such that the slots or recesses 144a, 144b and 144c correspond to the noses or protrusions 258a, 258b and 258c and they are engaged with one another. The first and the second connecting part 100 and 200 can be plugged or fitted into one another only in one rotational position about the longitudinal axis L, specifically when the slots or recesses correspond to the noses or protrusions and they are engaged with one another. In this example, in each case three protrusions and recesses are illustrated. It is particularly advantageous to choose an arrangement as described in DE 20 2007 005 316 A1. In FIGS. 20a and 20b, by way of example, one recess 258b and one protrusions 144b, which are engaged with one another, i.e. are arranged opposite one another, are shown.

In FIG. 20a, the O-ring 132 is just starting to make contact with the inner face 242 of the chamfer 242 and with the body edge 242b initially only at two points 300. Here, an advantage of the invention becomes apparent. It is not necessary for the O-ring 132 to be deformed around its entire circumference right at the start of fitting, rather it starts initially at two points, i.e. around a partial circumference, and, depending on the fitted state, the deformation takes place gradually around the entire circumference. As a result, the force required is reduced and plugging together is made easier.

FIG. 20b shows the fully fitted or plugged-together connecting parts 100 and 200. The connecting point or line is sealed by the plugging of the first connecting part 100 into the second connecting part 200 and the O-ring 132 in combination with the inner face 244 for a fluid that can flow through the inner openings 138 and 238. The connecting parts are aligned radially with respect to the longitudinal axis L via a tight tolerance, for example a fit h6/H7 according to DIN ISO 286, of the inner face 246 with the diameter D246 (H7, from 0 to +21 μm) with respect to the outer face 134 with the diameter D134 (h6, from −13 to 0 μm) or h7 (from −21 to 0 μm). The axial alignment with respect to the longitudinal axis L of the connecting parts with respect to one another occurs by way of the contact of the face 122 of the first connecting part 100 and the face 222 of the second connecting part 200.

Thus, easy fitting and clear axial and radial positioning with respect to the longitudinal axis L with a low tolerance with a simultaneously sealed connection are possible.

FIG. 21 shows, by way of example a nozzle 2 for a plasma torch, which has the features of the connecting part wo from FIG. 18. The nozzle has, at its front end, a nozzle bore or nozzle channel 46, which constricts a plasma jet. The plasma gas, which is ionized in order to generate the plasma het, is the fluid that flows through the interior 138. The plasma jet itself flows at least through a part of this interior 138 before it flows out through the nozzle channel 46. In this example, the nozzle has the features of the connecting part 100 from FIG. 18. Of course, all the other exemplary embodiments shown in the preceding figures are also possible.

Here, one feature is illustrated in order to keep the overall size of the nozzle as small as possible. The length L112 between the boundary 114, directed towards the rear end 104, of the slot and the rear end 104 with the face 108 is less than the slot width B130. In this case, it amounts to only 40% of the slot width B130.

FIG. 21a shows, by way of example, the same nozzle 2 with an O-ring 132 in the slot 130. In this example, the nozzle 2 has the features of the connecting part 100 from FIG. 18c. Of course, all the other exemplary embodiments shown in the preceding figures are also possible.

Here, a further feature is illustrated in order to keep the overall size of the nozzle as small as possible. The length L112a between the face, facing the rear end 104, of the O-ring 130 and the rear end 104 with the face 108 is less than the slot width B130. In this example, it amounts to only half the slot width B130.

Such a nozzle 2 having the features according to the invention can also be used for example in a laser processing head.

FIG. 22 shows essential constituents of a plasma torch head. These are at least one electrode 1, a nozzle 2, a nozzle receptacle 7 and a gas guide 4. The electrode is arranged in the inner cavity of the nozzle 2. Located between the electrode 1 and the nozzle 2 is a gas guide 4 for the plasma gas PG, which flows through the gas guide 4, then the space between the electrode 1 and the nozzle 2 and finally out of the nozzle opening. The nozzle 2 is plugged into the nozzle receptacle 7. In this case, the nozzle 2 can have the features of the connecting part 100, and all of the variants shown in the preceding figures are possible. The nozzle receptacle 7 can have the features of the connecting part 200. Here too, all of the variants shown in the preceding figures are possible.

It is likewise possible for the nozzle 2 to have the features of the second connecting part 200 and for the nozzle receptacle 7 to have the features of the first connecting part 100.

Since a nozzle is subject to heavy wear by the operation of the plasma torch, it is often necessary to change the nozzle. Therefore, the advantages of the invention, specifically the reduction in the force required during fitting, the good alignment parallel and radially with respect to the longitudinal axis L of the connecting parts with respect to one another and, depending on the embodiment, the rotational position with respect to the longitudinal axis L around the circumference of the connecting parts with respect to one another, individually or in any desired combination, make it easier to change the nozzle.

Furthermore, secure sealing is achieved between the interior of the nozzle 2 and the space outside the nozzle receptacle 7.

The plasma torch head shown here has, in addition to the abovementioned constituents, a nozzle cap 3, which fixes the nozzle 2, a protective cap 5, a gas guide 6, which is located between the protective cap 5 and the nozzle cap 3 and isolates these from one another, and the protective-cap mount 8, which holds the protective cap. The secondary gas SG flows through openings (not illustrated) in the gas guide 6, then through the space between the nozzle cap 3 and nozzle protective cap 5, and finally out of the front opening in the nozzle protective cap 5. It is also possible for the nozzle 2 and nozzle cap 3 to consist of one piece. Likewise, there are plasma arc torch heads, which are operated without secondary gas. These then generally have no nozzle protective cap and no nozzle protective-cap mount. The plasma torch head in the exemplary embodiment shown is a water-cooled plasma torch head. The cooling liquid flows via the cooling-liquid feed line WV through the nozzle holder 7, flows through the space 10 between the nozzle holder 7 and the nozzle 2, into the space between the nozzle 2 and the nozzle cap 3, before flowing back through the cooling-liquid return line WR.

The constituents shown, in particular the successive wearing parts such as the electrode 1, the gas guides 4 and 6, the nozzle cap 3, the nozzle protective cap 5, the nozzle receptacle 7 and the protective-cap mount 8 can have the features according to the invention. However, other constituents of the plasma torch head and of the entire plasma torch, in which connections have to be realized between two or more parts, for example in a quick-change torch between a plasma torch head and a plasma torch shaft, as is described in DE 10 2006 038 134 A1, can be equipped with these features.

The above description was based on connecting parts and wearing parts for a plasma torch head. The plasma torch head can be a plasma torch cutting head or a plasma welding torch head.

However, the description is intended to apply analogously also to connecting parts and wearing parts for laser processing, for example for laser cutting or laser welding, and thus for a laser cutting head or a laser welding head.

However, the description is intended to apply analogously also to connecting parts and wearing parts for plasma laser processing, for example for plasma laser cutting or plasma laser welding, and thus for a plasma laser cutting head or a plasma laser welding head.

The features of the invention that are disclosed in the present description, in the drawings and in the claims can be essential, both individually and in any desired combinations, for realizing the invention in its various embodiments.

### LIST OF REFERENCE SIGNS

1 Electrode
2 Nozzle
3 Nozzle gap
4 Gas guide, plasma gas PG
5 Protective cap
6 Gas guide, secondary gas SG
7 Nozzle holder
8 Protective-cap mount
46 Nozzle bore, nozzle channel
100 First connecting part
102 Front end
104 Rear end
106 Body
108 Face
110 Outer face
112 Face
114 Face, lateral face, lateral boundary face of the slot 130
116 Face, slot bottom
118 Face, lateral boundary face of the slot 130
120 Face, outer face
122 Face
124 Face
125 Flange
126 Face
128 Face, outer face
130 Slot
132 O-ring
132a Outermost face of the O-ring
132i Innermost face of the O-ring
134 Face, outer face, centring face
136 Face, outer face
138 Opening
140 Inner face
142 Chamfer
144 Face, outer face
144a, 144b, 144c Recess, slot
146 Face
200 Second connecting part
202 Front end
204 Rear end
206 Body
212 Outer face
214 Face, lateral boundary face of the slot 230
216 Face, slot bottom
218 Face, lateral boundary face of the slot 230
222 Face, stop face
230 Slot
232 O-ring
238 Opening
240 Inner face, centring face
242 Inner face, chamfer
242a Body edge
242b Body edge
244 Face, inner face
246 Inner face, centring face
248 Flange
250 Face, inner face
252 Face, inner face
254 Face, inner face
256 Face, inner face
258 Face, inner face
258a, 258b, 258c Protrusions, noses
300 Contact point
B130 Slot width
D112 Distance, diameter
D112ₘₐₓ Largest distance
D112ₘᵢₙ Smallest distance
D116 Distance
D116ₘₐₓ Largest distance
D116ₘᵢₙ Smallest distance
D120 Distance, diameter
D120ₘₐₓ Largest distance
D120ₘᵢₙ Smallest distance
D124 Diameter
D132a Distance
D132aₘₐₓ Largest distance
D132aₘᵢₙ Smallest distance
D132i Distance
D132iₘₐₓ Largest distance
D132iₘᵢₙ Smallest distance
D134 Diameter
D240 Diameter
D244 Distance
D244ₘₐₓ Largest distance
D244ₘᵢₙ Smallest distance
D246 Diameter
F Virtual fixed point
L Longitudinal axis
L112 Distance
L112ₘₐₓ Maximum distance
L112ₘᵢₙ Minimum distance
L112a Distance
L112aₘₐₓ Maximum distance
L112aₘᵢₙ Minimum distance
L116 Distance
L116ₘₐₓ Maximum distance
L120 Distance
L120ₘₐₓ Maximum distance
L120ₘᵢₙ Minimum distance
L120a Distance
L120aₘₐₓ Maximum distance
L120aₘᵢₙ Minimum distance
L124 Distance
L124ₘₐₓ Maximum distance
L124ₘᵢₙ Minimum distance
L124a Distance
L124aₘₐₓ Maximum distance
L124aₘᵢₙ Minimum distance
L128 Distance
L128ₘₐₓ Maximum distance
L128ₘᵢₙ Minimum distance
L128a Distance
L128aₘₐₓ Maximum distance
L128aₘᵢₙ Minimum distance
L212 Distance
L212ₘₐₓ Maximum distance
L212ₘᵢₙ Minimum distance
L216 Distance
L216ₘₐₓ Maximum distance
L220 Distance
L220ₘₐₓ Maximum distance
L220ₘᵢₙ Minimum distance
L224 Distance
L224ₘₐₓ Maximum distance
L224ₘᵢₙ Minimum distance
L228 Distance
L228ₘₐₓ Maximum distance
L228ₘᵢₙ Minimum distance
L228a Distance
L228aₘₐₓ Maximum distance
L228aₘᵢₙ Minimum distance
L242 Distance
L242bₘₐₓ Maximum distance
L242bₘᵢₙ Minimum distance
L243 Distance
M130 Virtual centre line of the slot 130
M132 Virtual centre line of the cord of the O-ring or profile ring
Sa Cord size
T112 Distance, slot depth
T112ₘₐₓ Largest distance
T112ₘᵢₙ Smallest distance
T120 Distance, slot depth
T120ₘₐₓ Largest distance
T120ₘᵢₙ Smallest distance
T130 Slot depth
α Angle

1. The connecting part for a processing head for thermal material processing, comprising:
a body that extends along a longitudinal axis having an outer face, an inner face, a front end, and a rear end; and
said outer face has at least one slot, extending in the circumferential direction, with each said slot having a slot depth and a slot bottom, wherein said slot bottom exhibits, around the circumference, different distances extending through the longitudinal axis and perpendicularly to the longitudinal axis between the opposite portions of said slot bottom, and said one outer face exhibits, around the circumference, different distances, extending through the longitudinal axis and perpendicularly to the longitudinal axis, between the opposite portions of said outer face; or
said inner face has at least one slot, extending in the circumferential direction, with each said slot having a slot depth and a slot bottom, wherein said slot bottom exhibits, around the circumference, different distances extending through the longitudinal axis and perpendicularly to the longitudinal axis between the opposite portions of said slot bottom and said inner face exhibits, around the circumference, different distances, extending through the longitudinal axis and perpendicularly to the longitudinal axis, between the opposite portions of said inner face.

2. The connecting part of claim 1 further comprising the distance extending through the longitudinal axis and perpendicularly to the longitudinal axis, between the opposite portions of said slot bottom exhibits at least one smallest distance and at least one largest distance and the difference between said largest distance and said smallest distance is between ¼ and 2 times said slot width or said slot depth.

3. The connecting part of claim 1 further comprising the distance extending through the longitudinal axis and perpendicularly to the longitudinal axis, between the opposite portions of said slot bottom exhibits at least one smallest distance and at least one largest distance and the difference between said largest distance and said smallest distance is between 0.4 mm and 3.0 mm.

4. The connecting part of claim 1 further comprising the distance extending through the longitudinal axis and perpendicularly to the longitudinal axis, between the opposite portions of said outer face exhibits at least one smallest distance and at least one largest distance and the difference between said largest distance and said smallest distance is between ¼ and 2 times said slot width or said slot depth.

5. The connecting part of claim 1 further comprising the distance extending through the longitudinal axis and perpendicularly to the longitudinal axis, between the opposite portions of said outer face exhibits at least one smallest distance and at least one largest distance and the difference between said largest distance and said smallest distance is between 0.4 mm and 3.0 mm.

6. The connecting part of claim 1 further comprising the distance, extending through the longitudinal axis and perpendicularly to the longitudinal axis, between the opposite portions of said inner face exhibits at least one smallest distance and at least one largest distance and the difference between said largest distance and said smallest distance is between ¼ and 2 times said slot width or said slot depth.

7. The connecting part of claim 1 further comprising the distance, extending through the longitudinal axis and perpendicularly to the longitudinal axis, between the opposite portions of said inner face exhibits at least one smallest distance and at least one largest distance and the difference between said largest distance and said smallest distance is between 0.4 mm and 3.0 mm.

8. The connecting part of claim 1 further comprising the length extending parallel to the longitudinal axis between a boundary directed towards said rear end of said slot and said rear end having a face that is less than half of said slot width.

9. The connecting part of claim 1 further comprising at least on one side of said slot, a lateral boundary face exhibits different distances extending axially with respect to the longitudinal axis between said slot bottom, said outer face, and said inner face.

10. The connecting part of claim 1 further comprising an O-ring or profile ring is located in said slot.

11. The connecting part of claim 10 further comprising said O-ring has an outermost face that protrudes from said slot via adjoining outer faces immediately adjoining said slot.

12. The connecting part of claim 10 further comprising said O-ring has an innermost face that protrudes from said slot via immediately adjoining inner faces.

13. The connecting part of claim 1 further comprising the connecting part is one of a wearing part, an electrode, a nozzle, a cap, a protective cap, a nozzle protective cap, a protective-cap mound, a gas guide, an insulating part, a combination thereof, a wearing-part mount therefor, a joint for a plasma torch head, a plasma torch shaft, a laser head or a plasma laser head, or a constituent of the joint between a plasma torch head and a torch shaft or a laser head and a laser shaft or a plasma laser head and a plasma laser shaft.

14. The connecting part of claim 10 further comprising a second connecting part that is able to be fit or plugged into the connecting part, wherein said O-ring or profile ring of the connecting part is in contact, in the fully fitted or plugged-together state of the connecting parts, around its entire circumference with the opposite inner face or outer face of said second connecting part and thus seals off the space between the inner and outer face.

15. The connecting part of claim 1 further comprising a second connecting part that is able to be fit or plugged into the connecting part, wherein in the fully fitted state, the alignment axially with respect to the longitudinal axis of the connecting parts occurs by way of the contact of a face (of the connecting part and a face of the second connecting part.

16. The connecting part of claim 1 further comprising a second connecting part that is able to be fit or plugged into the connecting part, wherein, in the fully fitted state, the alignment or centring radially with respect to the longitudinal axis of the connecting part with respect to the second connecting part occurs by way of an outer face of the connecting part with respect to an inner face of the second connecting part, which have tight tolerances with respect to one another and are at least partially in contact.

17. A connecting part for a processing head for thermal material processing, comprising:
a body that extends along a longitudinal axis with an outer face, an inner face, a front end, and a rear end;
said outer face or said inner face has at least one slot extending in the circumferential direction, having a slot width, a slot depth, and having an O-ring or profile ring with a cord size;
said O-ring or profile ring having a innermost face directed towards the longitudinal axis of said O-ring, said innermost face exhibits, around the circumference, different distances extending through the longitudinal axis and perpendicularly to the longitudinal axis between opposite portions of said innermost face; and
said O-ring or profile ring has an outermost face, said outermost face exhibits, around the circumference, different distances extending through the longitudinal axis and perpendicularly to the longitudinal axis between the opposite portions of said outermost face.

18. The connecting part of claim 17 further comprising the distance extending through the longitudinal axis and perpendicularly to the longitudinal axis exhibits at least one smallest distance and at least one largest distance and the difference between said largest distance and said smallest distance is in the range of ¼, to 2 times said slot width or said slot depth.

19. The connecting part of claim 17 further comprising the distance extending through the longitudinal axis and perpendicularly to the longitudinal axis exhibits at least one smallest distance and at least one largest distance and the difference between said largest distance and said smallest distance is in the range of ⅓ to 2 times said cord size, the diameter of said cord, or the width extending along the longitudinal axis of said O-ring or profile ring.

20. The connecting part of claim 17 further comprising the distance extending through the longitudinal axis and perpendicularly to the longitudinal axis exhibits at least one smallest distance and at least one largest distance and the difference between said largest distance and said smallest distance is in the range of 0.4 mm to 3.0 mm.

21. The connecting part of claim 17 further comprising said outermost face protrudes from said slot via said outer face immediately adjoining said slot.

22. The connecting part of claim 17 further comprising said innermost face protrudes from said slot via said inner faces immediately adjoining said slot.

23. The connecting part of claim 17 further comprising at least one further outer face which protrudes beyond said outermost face.

24. The connecting part of claim 17 further comprising at least one further outer face which protrudes beyond said outermost face and has recesses or slots.

25. The connecting part of claim 24 further comprising said outermost face does not protrude beyond the deepest portion of said recesses or slots.

26. The connecting part of claim 17 further comprising said rear end having a face; and
a length extending parallel to the longitudinal axis between that face of said 0-ring that faces said rear end and said face of said rear end is less than between ⅗ and ½ of said slot width.

27. The connecting part of claim 17 further comprising the connecting part is one of a wearing part, an electrode, a nozzle, a cap, a protective cap, a nozzle protective cap, a protective-cap mound, a gas guide, an insulating part, a combination thereof, a wearing-part mount therefor, a joint for a plasma torch head, a plasma torch shaft, a laser head or a plasma laser head, or a constituent of the joint between a plasma torch head and a torch shaft or a laser head and a laser shaft or a plasma laser head and a plasma laser shaft.

28. The connecting part of claim 17 further comprising a second connecting part that is able to be fit or plugged into the connecting part, wherein said O-ring or profile ring of the connecting part is in contact, in the fully fitted or plugged-together state of the connecting parts, around its entire circumference with the opposite inner face or outer face of said second connecting part and thus seals off the space between the inner and outer face.

29. The connecting part of claim 17 further comprising a second connecting part that is able to be fit or plugged into the connecting part, wherein in the fully fitted state, the alignment axially with respect to the longitudinal axis of the connecting parts occurs by way of the contact of a face (of the connecting part and a face of the second connecting part.

30. The connecting part of claim 17 further comprising a second connecting part that is able to be fit or plugged into the connecting part, wherein, in the fully fitted state, the alignment or centring radially with respect to the longitudinal axis of the connecting part with respect to the second connecting part occurs by way of an outer face of the connecting part with respect to an inner face of the second connecting part, which have tight tolerances with respect to one another and are at least partially in contact.
